(19) United States
(12) Patent Application Publication
(10) Pub. No.: US 2026/0213586 A1
(43) Pub. Date: Jul. 23, 2026

(54) ELECTRIC MACHINE

(71) Applicant: ELECTRIC TORQUE MACHINES, INC., Minneapolis, MN (US)

(72) Inventors: Thomas F. Janecek, Flagstaff, AZ (US); Tyler K. Williams, Flagstaff, AZ (US); Jeremy Scott Reynolds, Flagstaff, AZ (US); Timothy S. Roman, Minnetonka, MN (US); Joseph E. Tix, Hastings, MN (US)

(21) Appl. No.: 19/140,528

(22) PCT Filed: Dec. 18, 2023
(86) PCT No.: PCT/US2023/084588

§ 371 Date: Jun. 18, 2025

Related U.S. Application Data
(60) Provisional application No. 63/434,497, filed on Dec. 22, 2022.
(60) Provisional application No. 63/523,809, filed on Jun. 28, 2023.

(51) Int. Cl. H02K 1/14; H02K 1/18; H02K 3/28; H02K 3/52

(52) U.S. Cl. CPC H02K 1/145; H02K 1/148; H02K 1/185; H02K 3/28; H02K 3/522; H02K 2213/12

(57) ABSTRACT

An electric machine includes a rotor configured to rotate on an axis and a stator spaced radially from the rotor. The stator includes a plurality of stator phases arrayed along the axis, each stator phase including a pair of flux rings and a coil extending about the axis and disposed between the pair of flux rings. The coil is formed form ribbon strand and a narrow edge of the ribbon strand is oriented radially. The flux rings are formed by ring segments that each extend partially about the axis and radially overlap with each other. The flux rings are aligned by pins that span between the flux rings. Adjacent stator phases are aligned by annular brackets that interface with the adjacent stator phases.

### CROSS-REFERENCE TO RELATED APPLICATION(S)

This application claims priority to U.S. Provisional Application No. 63/434,497 filed Dec. 22, 2022 and entitled “ELECTRIC MOTOR DRIVE,” and claims priority to U.S. Provisional Application No. 63/523,809 filed Jun. 28, 2023, and entitled “ELECTRIC MACHINE HAVING A ROTOR AND A STATOR,” the disclosures of which are hereby incorporated by reference in their entireties.

### BACKGROUND

The present disclosure relates generally to electric machines. More specifically, the present disclosure relates to transverse flux electric machines.

Electric motors utilize electricity to generate a mechanical output. Some electric motors generate rotational outputs. In alternating current (AC) induction motors, a stator is electrically energized to electromagnetically drive rotation of a rotor about a motor axis. The stator includes laminates and windings. The rotor includes permanent magnets that are acted on by the electromagnetic field induced by current through the stator to cause rotation of the rotor. Such electric motors include coils that extend axially relative to the rotational axis and that extend axially beyond the ends of the rotor to wrap around and form the ends of the coil windings.

### SUMMARY

According to an aspect of the disclosure, an electric machine includes a rotor configured to rotate on an axis; and a stator spaced radially relative to the rotor and disposed about the axis, the stator comprising a plurality of stator phases disposed along the axis. Each stator phase including a pair of flux rings, each flux ring including an annular array of teeth; a coil disposed axially between the pair of flux rings and extending fully around the axis; and an annular array of axial returns extending between the pair of flux rings to magnetically connect the pair of flux rings. A first coil of a first stator phase of the plurality of stator phases is wound from a first ribbon strand, the first ribbon strand wound along the axis such that a narrow side of the first ribbon strand is oriented radially and layers of the first ribbon strand are stacked axially.

According to an additional or alternative aspect of the disclosure, a coil for use in a stator phase of an electric machine, the stator phase including a pair of flux rings with each flux ring of the pair of flux rings including an annular array of teeth, and the stator phase including an annular array of axial returns extending between the pair of flux rings to electromagnetically connect the pair of flux rings, the coil including a first ribbon strand wound about an axis and stacked along the axis such that a narrow side of the first ribbon strand is oriented radially towards the axis, a broad side of the first ribbon strand is oriented axially, and layers of the first ribbon strand are stacked axially.

According to another additional or alternative aspect of the disclosure, a coil for use in a stator phase of an electric machine, the stator phase including a pair of flux rings, each flux ring of the pair of flux rings including an annular array of teeth, and an annular array of axial returns extending between the pair of flux rings to electromagnetically connect the pair of flux rings, the coil including a first ribbon strand wound about an axis and stacked along the axis such that a narrow side of the first ribbon strand is oriented radially towards the axis and layers of the first ribbon strand are stacked axially to form a stacked body; a first terminal end of the first ribbon strand extending radially relative to the stacked body; a second terminal end of the first ribbon strand extending radially relative to the stacked body; and a bend that axially offsets adjacent turns of the first ribbon strand.

According to yet another additional or alternative aspect of the disclosure, a coil for use in a stator phase of an electric machine, the stator phase including a pair of flux rings, each flux ring of the pair of flux rings including an annular array of teeth, and an annular array of axial returns extending between the pair of flux rings to electromagnetically connect the pair of flux rings, the coil including a first ribbon strand wound about an axis and stacked along the axis such that a narrow edge of the first ribbon strand is oriented radially towards the axis and layers of the first ribbon strand are stacked axially; and a second ribbon strand wound about the axis and stacked along the axis such that a narrow edge of the second ribbon strand is oriented radially towards the axis and layers of the second ribbon strand are stacked axially.

According to yet another additional or alternative aspect of the disclosure, a flux ring for a stator phase of a stator of an electric machine, the flux ring including a plurality of ring segments including a first ring segment extending partially about an axis and a second ring segment extending partially about the axis. The first ring segment including a first segment body extending between a first body first circumferential end and a first body second circumferential end; at least one first tooth projecting radially from the first segment body; and a receiver formed in the first body first circumferential end. The second ring segment including a second segment body extending between a second body first circumferential end and a second body second circumferential end; at least one second tooth projecting radially from the second segment body; and a projection formed on the second body second circumferential end, the projection extending into the receiver such that the first ring segment radially overlaps with the second ring segment.

According to yet another additional or alternative aspect of the disclosure, a flux ring for a stator phase of a stator of an electric machine, the flux ring including a plurality of ring segments, each ring segment of the plurality of ring segments extending partially about the axis and including a segment body extending between a first circumferential end and a second circumferential end; at least one first tooth projecting radially from the segment body; a projection extending from the first circumferential end; and a receiver extending into the second circumferential end. The plurality of ring segments are fit end-to-end about the axis such that the projection of each ring segment of the plurality of ring segments extends into the receiver of another ring segment of the plurality of ring segments such that adjacent ring segments of the plurality of ring segments radially overlap. At least one circumferential gap is formed fully radially through the flux ring and between at least one set of the adjacent ring segments.

According to yet another additional or alternative aspect of the disclosure, a stator phase for a stator of an electric machine, the stator phase including a first flux ring extending about an axis, the first flux ring including a plurality of first teeth and including a plurality of ring segments, wherein each ring segment of the plurality of ring segments includes a first circumferential end; a second circumferential end; a projection extending from the first circumferential end; and a receiver formed in the second circumferential end. The plurality of ring segments are fit end-to-end such that for each ring segment the projection extends into the receiver of an adjacent ring segment. The stator phase further including a second flux ring extending about the axis, the second flux ring including a plurality of second teeth; a coil extending about the axis and disposed directly axially between the first flux ring and the second flux ring; and an array of axial returns extending between the first flux ring and the second flux ring to electromagnetically connect the first flux ring and the second flux ring.

According to yet another additional or alternative aspect of the disclosure, an electric machine including a rotor configured to rotate on an axis; and a stator spaced radially relative to the rotor and disposed about the axis, the stator comprising a plurality of stator phases disposed along the axis. A first stator phase of the plurality of stator phases including a first flux ring, the first flux ring having a plurality of first teeth; a second flux ring, the second flux ring having a plurality of second teeth; a first coil extending fully annularly about the axis and disposed directly axially between the first flux ring and the second flux ring; and a first annular array of axial returns extending about the axis and disposed on an opposite radial side of the first flux ring from the rotor. The electric machine further including a first annular bracket interfacing with the first annular array of axial returns to hold the first annular array of axial returns on the first flux ring.

According to yet another additional or alternative aspect of the disclosure, an electric machine includes a rotor configured to rotate on an axis; and a stator spaced radially relative to the rotor and disposed about the axis, the stator comprising a plurality of stator phases disposed along the axis, a first stator phase of the plurality of stator phases including a first flux ring, the first flux ring having a plurality of first teeth; a second flux ring, the second flux ring having a plurality of second teeth; a first coil extending fully annularly about the axis and disposed directly axially between the first flux ring and the second flux ring; and an first annular array of axial returns extending about the axis and disposed on an opposite radial side of the first flux ring from the rotor. The electric machine further including a first annular bracket extending about the axis, the first annular bracket including a first locator that extends into a mounting slot of the first flux ring to locate the first flux ring about the axis.

According to yet another additional or alternative aspect of the disclosure, an electric machine includes a rotor configured to rotate on an axis; and a stator spaced radially relative to the rotor and disposed about the axis, the stator comprising a plurality of stator phases disposed along the axis. A first stator phase of the plurality of stator phases includes a first flux ring, the first flux ring having a plurality of first teeth; a second flux ring, the second flux ring having a plurality of second teeth; a first coil extending fully annularly about the axis and disposed directly axially between the first flux ring and the second flux ring; and a first annular array of axial returns extending about the axis and disposed on an opposite radial side of the first flux ring from the rotor. A second stator phase of the plurality of stator phases includes a third flux ring, the first flux ring having a plurality of third teeth; a fourth flux ring, the second flux ring having a plurality of fourth teeth; a second coil extending fully annularly about the axis and disposed directly axially between the third flux ring and the fourth flux ring; and a second annular array of axial returns extending about the axis and disposed on an opposite radial side of the third flux ring from the rotor. A first annular bracket extending about the axis, the first annular bracket interfacing with the first annular array of axial returns to hold the first annular array of axial returns on the first flux ring. A second annular bracket extending about the axis, the second annular bracket interfacing with the first annular array of axial returns to hold the first annular array of axial returns on the second flux ring and the second annular bracket interfacing with the second annular array of axial returns to hold the second annular array of axial returns on the third flux ring.

According to yet another additional or alternative aspect of the disclosure, an annular bracket for use in an electric machine that includes a stator and a rotor configured to rotate on an axis, the annular bracket including an annular bracket body extending about the axis; a plurality of retaining tabs extending from a radial edge of the annular bracket body and projecting axially outward relative to the annular bracket body; and at least one locator projects axially outward from the annular bracket body.

According to yet another additional or alternative aspect of the disclosure, an electric machine includes a rotor configured to rotate on an axis; and a stator spaced radially relative to the rotor and disposed about the axis, the stator comprising a plurality of stator phases disposed along the axis. A first stator phase of the plurality of stator phases includes a first flux ring, the first flux ring having a plurality of first teeth, wherein a first alignment slot is formed in the first flux ring; a second flux ring, the second flux ring having a plurality of second teeth, wherein a second alignment slot is formed in the second flux ring; a first coil extending fully annularly about the axis and disposed directly axially between the first flux ring and the second flux ring; a first annular array of axial returns extending about the axis and disposed on an opposite radial side of the first flux ring from the rotor; and a first pin bridging between the first flux ring and the second flux ring and extending into the first alignment slot and the second alignment slot to align the first flux ring and the second flux ring about the axis.

According to yet another additional or alternative aspect of the disclosure, a stator phase for an electric machine includes a first flux ring, the first flux ring having a plurality of first teeth, wherein a first alignment slot is formed in the first flux ring; a second flux ring, the second flux ring having a plurality of second teeth, wherein a second alignment slot is formed in the second flux ring; a first coil extending fully annularly about the axis and disposed directly axially between the first flux ring and the second flux ring; a first annular array of axial returns extending about the axis and disposed on an opposite radial side of the first flux ring from the rotor; and a first pin bridging between the first flux ring and the second flux ring and extending into the first alignment slot and the second alignment slot to align the first flux ring relative to the second flux ring about the axis.

According to yet another additional or alternative aspect of the disclosure, an electric machine includes a housing; a rotor configured to rotate on an axis; and a stator spaced radially relative to the rotor and disposed about the axis and at least partially within the housing, the stator comprising a plurality of stator phases disposed along the axis. A first stator phase of the plurality of stator phases includes a first flux ring, the first flux ring having a plurality of first teeth; a second flux ring, the second flux ring having a plurality of second teeth; a first coil extending fully annularly about the axis and disposed directly axially between the first flux ring and the second flux ring; and a first annular array of axial returns extending about the axis and disposed on an opposite radial side of the first flux ring from the rotor. A first axial return of the annular array of axial returns includes a return face oriented radially away from the first flux ring and extending between a first circumferential side of the axial return and a second circumferential side of the axial return. The return face is contoured such that a radial body thickness of the first axial return is greater than a radial edge thickness of the first axial return.

According to yet another additional or alternative aspect of the disclosure, an electric machine includes a housing; a rotor configured to rotate on an axis; and a stator spaced radially relative to the rotor and disposed about the axis and within the housing, the stator comprising a plurality of stator phases disposed along the axis. A first stator phase of the plurality of stator phases includes a first flux ring, the first flux ring having a plurality of first teeth; a second flux ring, the second flux ring having a plurality of second teeth; a first coil extending fully annularly about the axis and disposed directly axially between the first flux ring and the second flux ring; and a first annular array of axial returns extending about the axis and disposed on an opposite radial side of the first flux ring from the rotor. A first axial return of each axial return of the first annular array of axial returns has a varied radial thickness across a circumferential width of the each axial return.

According to yet another additional or alternative aspect of the disclosure, an axial return for use in a stator phase of an electric machine, the axial return includes a plurality of lamina sheets stacked together, each lamina sheet of the plurality of lamina sheets having an axial grain orientation and extending between a first axial end of the axial return and a second axial end of the axial return; and a return face extending between a first side of the axial return and a second side of the axial return, wherein the return face is contoured such that the axial return has a varied radial thickness between the first side and the second side.

### BRIEF DESCRIPTION OF THE DRAWINGS

FIG. 1 is a block diagram of an electric machine.

FIG. 2 is a block diagram of an electric machine.

FIG. 3 is a simplified cross-sectional view of an electric machine.

FIG. 4 is an isometric view of a rotor.

FIG. 5 is a partially exploded view of a stator.

FIG. 6 is an isometric view of a stator phase.

FIGS. 7A and 7B are isometric cross-sectional views of a portion of a stator phase that demonstrate how flux circuits are formed through flux paired teeth of a stator phase.

FIG. 7C is a detailed end view showing flux paired teeth of a stator phase and a magnetic array of a rotor.

FIG. 8 is an isometric view of an inner annular bracket.

FIG. 9 is an isometric view of an outer annular bracket.

FIG. 10 is an enlarged isometric view of a retaining tab of an annular bracket.

FIG. 11 is an end view of a stator phase.

FIG. 12A is an enlarged view of detail A in FIG. 11.

FIG. 12B is an enlarged view of detail B in FIG. 11.

FIG. 13 is an exploded view of a stator phase.

FIG. 14 is an isometric view of a stator.

FIG. 15 is an isometric view of a stator.

FIG. 16 is an isometric view of a coil.

FIG. 17 is an isometric view of a coil.

FIG. 18 is an isometric view of a coil.

FIG. 19 is an enlarged plan view of a portion of the coil shown in FIG. 18.

FIG. 20 is an isometric view showing multiple coils connected to electrical connectors.

FIG. 21 is an isometric view of a stator showing the electrical connectors of FIG. 20.

FIG. 22 is an isometric view of a stator showing electrical connectors.

FIG. 23 is a partial isometric view of a stator phase.

FIG. 24 is an axial end view showing a motor with the stator and rotor exposed.

### DETAILED DESCRIPTION

The present disclosure concerns electric machines. The main type of electric machine presented herein is a transverse flux machine, which is distinguished from axial or radial flux type electric machines. However, the inventive aspects discussed herein can be applied to various types of electric machines beyond just transverse flux electric machines. It is understood that, while the electric machine is generally discussed as being an electric motor, the principles discussed herein are applicable to other electric machines, such as generators.

The electric machines of this disclosure include a rotor rotatable on a motor axis and a stator disposed about the axis and spaced radially from the rotor. The stator can drive rotation of the rotor in examples in which the electric machine is an electric motor. According to aspects of the disclosure, the stator of the transverse flux electric motor includes stator phases, such as one, two, three, or more, formed from flux rings and a coil disposed axially between opposing flux rings. In examples including three phases, such phase can operate 120-degrees electrically offset with respect to each other. The phases are arrayed along the axis of rotation of the rotor. Likewise, the coils which generate electromagnetic flux are coaxial with the axis of rotation and the multiple coils of the different phases are arrayed along the axis of rotation. The phases, which operate offset with respect to each other, are arrayed along the axis of rotation. Likewise, coils which generate electromagnetic flux are positioned coaxial with the axis of rotation and the multiple coils of the different phases are arrayed along the axis of rotation. Aspects of the disclosure discussed herein can be implemented in other types of electric machines, but transverse flux motors will be discussed further herein.

According to aspects of the disclosure, one or more coils of the stator are edge wound. The edge wound coil is formed from a ribbon strand that is wound about the axis to form the coil. The edge wound coil has a narrow edge of the ribbon strand oriented radially and a broad side of the ribbon strand oriented axially. The ribbon strand is wound about the axis such that the ribbon strand is stacked along the axis to form a stacked body of the coil. According to aspects of the disclosure, an edge wound coil can include multiple ribbon strands that are disposed electrically in parallel to form the coil. The multiple ribbon strands can be interleaved in some examples. The multiple ribbon strands can be stacked axially on each other. According to additional or alternative aspects of the disclosure, the edge wound coil can include a bend that axially offsets adjacent turns of the stacked body of the coil.

According to additional or alternative aspects of the disclosure, the flux ring can include a circumferential gap extending fully through the flux ring from an inner radial side to an outer radial side of the flux ring. The circumferential gap prevents formation of a common metallic link fully about the axis. The circumferential gap can be at least partially formed between a projection extending from a circumferential end of one portion of the flux ring extending into a receiver formed in a circumferential end of another portion of the flux ring. The projection extends into the receiver such that the portions of the flux ring radially overlap.

According to additional or alternative aspects of the disclosure, flux rings of a stator phase can be formed by ring segments that extends partially about the axis. The ring segments can be fit end-to-end to form the annular flux ring. Adjacent ring segments can be fit together by a projection of one of the ring segments extending into a receiver of the other ring segment such that the adjacent ring segments radially overlap.

According to additional or alternative aspects of the disclosure, one or more pins can extend between flux rings of a stator phase to axially align the flux rings. In some examples, the one or more pins can span between adjacent stator phases to align the stator phases relative to each other about the axis.

According to additional or alternative aspects of the disclosure, one or more annular brackets can interface with axial returns of a stator phase to hold the axial returns on the flux rings of the stator phase.

According to additional or alternative aspects of the disclosure, an annular bracket can include a locator that extends into a mounting slot formed on a flux ring of a stator phase. The locator interfaces with the flux ring to fix a position of the flux ring circumferentially relative to the annular bracket. In some examples, the annular bracket can be disposed axially between adjacent stator phases. In such an example, the annular bracket can include one or more locators that interface with a flux ring of a first stator phase and one or more locators that interface with a flux ring of a second stator phase axially adjacent to the first stator phase.

According to additional or alternative aspects of the disclosure, an axial return of an annular array of axial returns can include a contoured outer face such that a radial thickness of the axial return varies at different locations across a width of the axial return. The outer face can be stepped. According to additional or alternative aspects of the disclosure, the axial return can include a notch disposed at the end of the axial return, the notch configured to interface with a retaining tab that holds the axial return on a flux ring. The term annular is used herein, which can refer to a ring shape (continuous or broken) about the axis, which can be coaxial with the axis. The term radial is used herein which when referring to a direction is any direction orthogonal to the axis, which can be 360-degrees about the axis, unless otherwise noted. The term axial is used herein which when referring to a direction is any direction along, such as parallel with, an axis, unless otherwise noted. The terms circumferential or circumferentially as used herein means around the common axis, unless otherwise noted.

Components can be considered to radially overlap when those components are disposed at common axial locations along an axis and such that a line extending radially from the axis will extend through each of the radially overlapping components. Components can be considered to axially overlap when those components are disposed at common radial and circumferential locations relative to an axis such that an axial line parallel to the axis extends through each of the axially overlapping components. Components can be considered to circumferentially overlap when aligned about the axis at a common radial distance from the axis such that a circle centered on the axis passes through each of the circumferentially overlapping components.

It is noted that for the discussion of this disclosure, some structures may be shown multiple times in a single example but only discussed or labeled once, for brevity. However, similar structures shown elsewhere can be constructed and function similarly as described and/or shown.

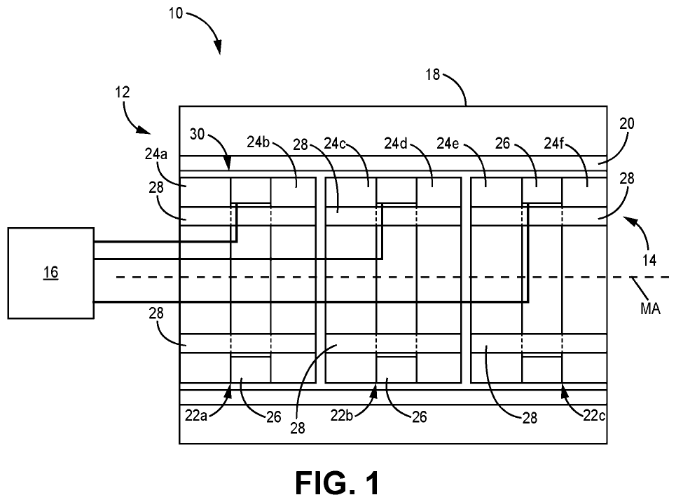

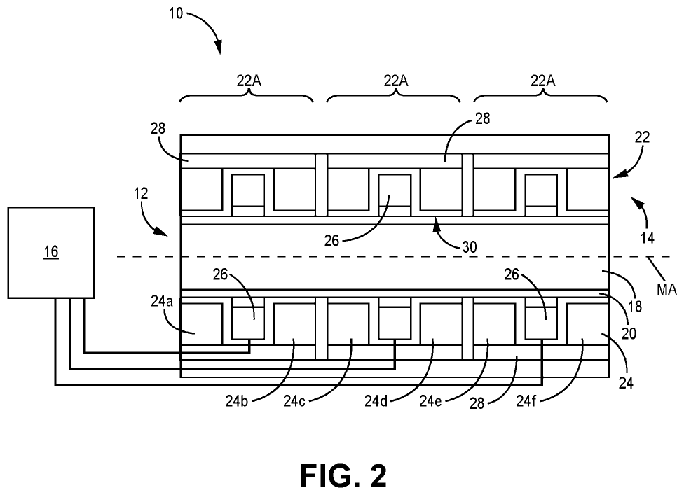

FIG. 1 is a block diagram of electric motor 10. FIG. 2 is a block diagram of electric motor 10. FIG. 1 shows electric motor 10 in an outer rotator configuration in which the rotor 12 is spaced radially outward from the stator 14. FIG. 2 shows electric motor 10 in an inner rotator configuration in which the rotor 12 is spaced radially inward from the stator 14. FIGS. 1 and 2 are discussed together. Electric motor 10 includes rotor 12, stator 14, and motor controller 16. Rotor 12 includes rotor body 18 and permanent magnet array 20. Stator 14 includes stator phases 22a, 22b, 22c (collectively herein “stator phase 22” or “stator phases 22”). Stator phase 22a includes flux rings 24a, 24b, coil 26, and axial returns 28. Stator phase 22b includes flux rings 24c, 24d, coil 26, and axial returns 28. Stator phase 22c includes flux rings 24e, 24f, coil 26, and axial returns 28. Flux rings 24a-24f are referred to collectively herein as “flux rings 24” or “flux ring 24”.

Rotor 12 is spaced radially from stator 14 such that air gap 30 is formed between rotor 12 and stator 14. Electric motor 10 extends along motor axis MA and rotor 12 is configured to rotate about motor axis MA. Motor axis MA can be considered to be an axis of rotation of the rotor 12. In the example shown in FIG. 1, rotor 12 surrounds stator 14 such that electric motor 10 is an outer rotator. In the example shown in FIG. 2, electric motor 10 include stator 14 extending about rotor 12 such that electric motor 10 is an inner rotator. Permanent magnet array 20 is mounted to the rotor body 18. Permanent magnet array 20 is disposed across air gap 30 from stator 14 such that permanent magnet array 20 is spaced radially from stator 14. Permanent magnet array 20 includes a plurality of permanent magnets disposed annularly about motor axis MA.

Stator 14 is formed by stator phases 22 arrayed along the motor axis MA. Each stator phase 22 includes paired flux rings 24 that are disposed on opposite axial sides of a coil 26 of that stator phase 22. The coil 26 is disposed directly axially between the flux rings 24 of the same stator phase 22. Flux rings 24a, 24b are paired to form stator phase 22a and are disposed on opposite axial sides of the coil 26 of stator phase 22a. Flux rings 24c, 24d are paired to form stator phase 22b and are disposed on opposite axial sides of the coil 26 of stator phase 22b. Flux rings 24e, 24f are paired to form stator phase 22c and are disposed on opposite axial sides of the coil 26 of stator phase 22c.

In some examples, portions of each flux ring 24 can extend axially over the coil 26. As such, portions of each flux ring 24 can be disposed directly radially between the coil 26 and permanent magnet array 20. Flux rings 24 are formed by laminations and can include powdered metal components.

Laminations can be formed from material which is readily susceptible to polarization from the fields generated by coils 26. Such material is typically ferromagnetic. The ferromagnetic materials can be metal such as iron or an alloy of iron, such as steel. More specially, laminations can be formed from silicon steel, among other options. Ferromagnetic material can be a ceramic that is doped or otherwise embedded with ferromagnetic elements. The laminations can be stacked together to form lamination stacks.

For each stator phase 22, axial returns 28 are disposed on an opposite radial side of coil 26 from permanent magnet array 20. Axial returns 28 extend between and connect paired ones of the flux rings 24 in each stator phase assembly 22. Axial returns 28 electromagnetically connect the paired flux rings 24. Axial returns 28 can be formed by stacked laminations having an axially oriented lamination grain (e.g., parallel with the motor axis MA). The laminations forming the axial returns 28 can be stacked circumferentially along a width of the axial return and extend axially along a length of the axial return 28.

Each coil 26 is a winding, typically copper, around the motor axis MA. Thus, each coil 26 could be a continuous winding of multiple loops (e.g., 2, 3, 4, 5, 10, 15, 20, 40, 50, 100, or more) around the motor axis MA. Examples of the winding can be formed by round wire or ribbon strand.

Controller 16 is operably connected to electric motor 10, electrically or communicatively, to control operation of electric motor 10, thereby controlling the rotational output of electric motor 10. Controller 16 can be of any desired configuration for controlling operation of electric motor 10 and can include control circuitry (e.g., one or more of a processor, a microprocessor, a controller, a digital signal processor (DSP), an application specific integrated circuit (ASIC), a field-programmable gate array (FPGA), other equivalent discrete or integrated logic circuitry, etc.) and computer-readable memory. Controller 16 is configured to store executable code, implement functionality, and/or process instructions. Controller 16 is configured to perform any of the functions discussed herein, including controlling operation of any components referenced herein. Controller 16 can be of any suitable configuration for controlling operation of electric motor 10, gathering data, processing data, etc. Controller 16 can include hardware, firmware, and/or stored software. Controller 16 can be of any type suitable for operating in accordance with the techniques described herein. While controller 16 is illustrated as a single unit, it is understood that controller 16 can be entirely or partially mounted on one or more circuit boards. In some examples, controller 16 can be implemented as a plurality of discrete circuitry subassemblies.

During operation, an alternating current (AC) signal is run through each coil 26. The AC signal rapidly builds and collapses the magnetic field due to the current reversal of the AC signal through the coil 26. Flux concentrating material of each stator phase assembly 22 (e.g., the flux rings 24 and axial returns 28) is wrapped around at least three sides of the coil 26. Generally, magnetic flux flows with the grain, along the direction of lamination, as flux will generally follow the path of highest permeability and there is significant resistance to flux jumping from one layer of lamination to another layer of lamination. At least a portion of the lamination grain of the flux rings 24 can be radially orientated relative to motor axis MA while the lamination grain of the axial returns 28 can be axially oriented relative to motor axis MA. As such, the flux can flow axially through the axial returns 28 and radially through flux rings 24 in a U-shaped path about coil 26 and towards rotor 12.

The AC signal routed through the coil 26 is synchronized to develop magnetic fields through the flux rings 24 in time with the rotational position of permanent magnet array 20 to drive rotation of rotor 12. The respective AC signals (e.g., sinusoidal or trapezoidal) delivered through the coils 26 in each stator phase 22a, 22b, 22c are out of stator phase with respect to each other. In this way, the magnets forming the permanent magnet array 20 more frequently have flux peaks acting on them, as compared to synchronizing the sinusoidal AC signals, thereby providing a smoother torque profile acting on the rotor 12 along the motor axis MA. The examples of the electric motor 10 discussed in FIGS. 1 and 2 has three stator phases corresponding to the three stator phases 22a, 22b, 22c and respective coils 26 therein. As such, three sinusoidal AC signals are delivered through the coils 26 120-degrees electrically offset. It is understood that not all examples are so limited. For example, the motor 10 can include two phases (e.g., with 180-degrees electrically offset signals), four phases (e.g., with 90-degrees electrically offset signals), six phases (e.g., with 60-degrees electrically offset signals), etc. In some examples, pairs of the phases (e.g., three phase pairs in a six phase example) can be provided with electrically aligned signals such that the electric signals are electrically offset between phase pairs but electrically aligned within the phase pair (e.g., three phase pairs for a six phase example). It is further understood that, while electric motor 10 is generally discussed as being an electric motor, electric motor 10 can be a generator.

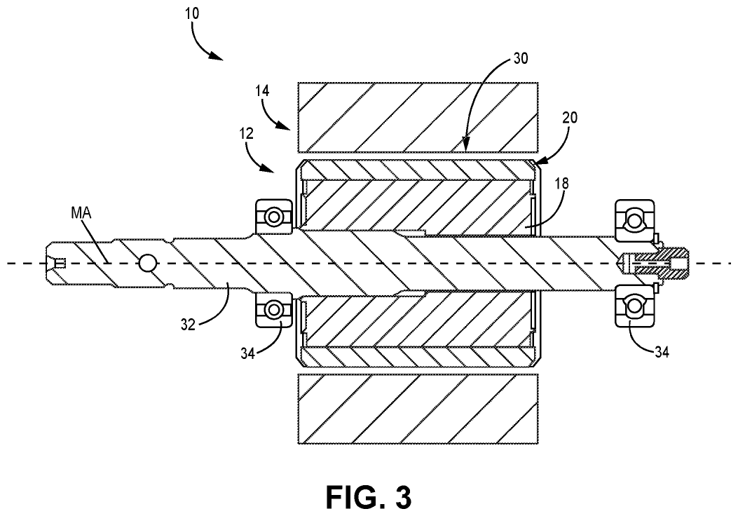

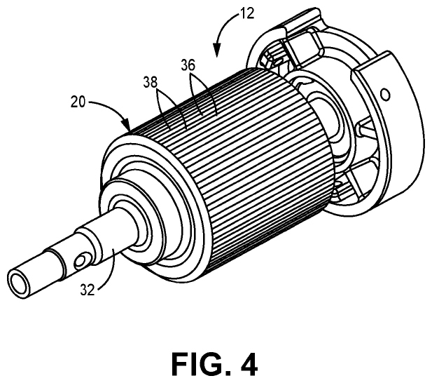

FIG. 3 shows a cross-sectional view of an electric motor 10. The axis of rotation MA of the rotor 14 is indicated. The electric motor 10 includes a rotor 14 and a stator 12. The rotor 14 is mounted on a shaft 32. Bearings 34 support the shaft 32. The rotor body 18 is supported by the shaft 32 and the rotor body 18 is configured to support magnet array 20. The magnet array 20 includes permanent magnets 36 (FIG. 4). The magnetic array 20 can include concentrators 38 (FIG. 4) (e.g., formed from stacked lamina or powdered metal) interspersed with the magnets 36. While the rotor 14 is located within the stator 12 in the example shown such that motor 10 is an inner rotating motor, in some other examples the rotor 14 is located radially outward from the stator 12 such that the motor 10 is an outer rotating motor. The bearings 34 interface with the shaft 32 to rotatably support the rotor 14 relative to a housing (not shown).

FIG. 4 is an isometric view of a rotor 14. The rotor 14 includes an annular array of magnets 36 supported by a rotor body 18. Interspaced with the magnets 36 are concentrators 38, which can be stacked steel laminations, amongst other options. The laminations of concentrators 38 can have an axial grain orientation and be stacked circumferentially to form each concentrator 38. Shaft 32 extends axially outward from rotor body 18 in the example shown.

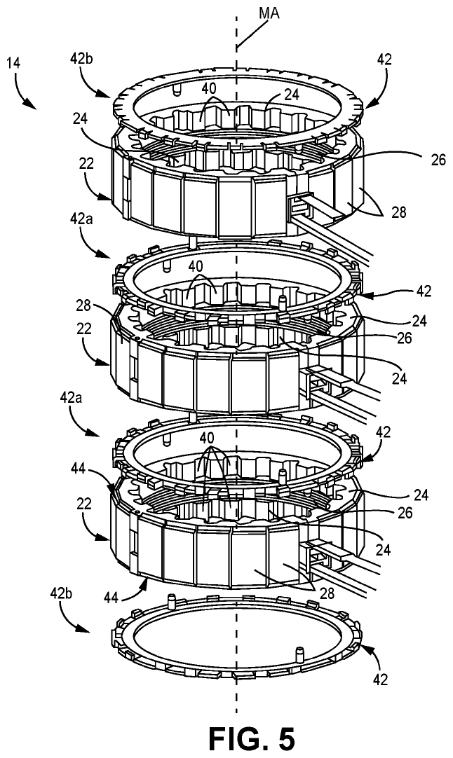

FIG. 5 is a partially exploded view of stator 14. Stator phases 22 are shown. In the example shown, the stator 14 includes three stator phases 22, however different examples can include different number of stator phases 22. In the examples shown, the driving signals for the coil 26 of each stator phase 22 are generally 120-degrees electrically offset relative to the signals of the coils 26 of the other stator phases 22. Each stator phase 22 comprises two annular flux rings 24, which can include solid structure extending fully about the axis MA or can be formed by ring segments arrayed about the axis MA. Each flux ring 24 includes an array of teeth 40 disposed about the axis MA. The teeth 40 extend towards the rotor 12 and are configured to concentrate magnetic flux towards the rotor 12. Each stator phase 22 includes a coil 26 between the two annular rings of teeth 40. The coil 26 receives an A/C signal to generate electromagnetic flux which travels through the axial returns 28 and the flux rings 24 to concentrate the flux across the air gap 30 between the rotor 12 and the stator 14. Magnets 36 of the rotor 12 are then pushed and/or pulled by the electromagnetic flux to rotate the rotor 12 relative to the stator 14. Electrical current can be inducted in the coils 26 by rotation of the rotor 12 by an external force in the manner of a generator, in some examples.

Brackets 42 are configured to align stator phases 22 on the axis MA. Brackets 42 include inner annular brackets 42a and outer annular brackets 42b. At least some of brackets 42 can interface with multiple of stator phases 22 to align the stator phases 22 relative to each other for desired alignment to drive rotation of the rotor 12. The electrical driving signals are 120-degrees offset in the example shown and the stator phases 22 are rotationally offset relative to each other about the axis MA. In some other examples, the stator phases 22 can be rotationally aligned. In either example, brackets 42 are configured to locate stator phases 22 relative to each other and about the axis MA and can hold stator phases 22 relative to each other, such as for during the potting process.

The brackets 42 can interface with at least one of the annular arrays of axial returns 28 of a stator 14 to hold the at least one of the annular arrays of axial returns 28 such that each annular array of axial returns 28 is held by and between two annular brackets 42 of the plurality of annular brackets 42. An annular bracket 42 can interface with a first annular array of axial returns 28 of a first stator phase 22 to hold the first annular array of axial returns 28 on a first flux ring 24 of the first stator phase 22.

Located between the stator phases 22 are inner annular brackets 42a. In the example shown, the inner annular brackets 42 are disposed directly axially between adjacent ones of the stator phases 22. Located on the ends of the stator 14 are outer annular brackets 42b. Outer annular brackets 42 are configured to interface with a single stator phase 22 located on the axial end of the stator 14. The outer annular brackets 42 can be considered to interface with the axially outermost stator phases 22.

Outer annular brackets 42b are configured to interface with the axially outer sides of the axially outer stator phases 22 of stator 14. In the example shown, each outer annular bracket 42b interfaces with a single stator phase 22 of the stator 14. Inner annular brackets 42a are disposed axially between adjacent stator phases 22. The inner annular brackets 42a are disposed axially within the stator 14. The inner annular brackets 42a are configured to interface with multiple stator phases 22. Each inner annular bracket 42a interfaces with two stator phases 22 in the example shown.

The annular brackets 42 are generally formed from polymer material. The annular brackets 42 can hold the axial returns 28 and position such axial returns 28 with respect to the flux rings 24. The annular brackets 42 can interface with the axial returns 28 to hold the axial returns 28 on the flux rings 24. In the example shown, the outer annular brackets 42b can each interface with a single array of axial returns 28 while the inner annular brackets 42a can each interface with multiple arrays of axial returns 28. The inner annular brackets 42a can interface with arrays of axial returns 28 of adjacent stator phases 22 to hold each array of axial returns 28 on the flux rings 24 of its respective stator phase 22. Each annular brackets 42 can interface with each axial return 28 forming an array of axial returns 28. It is understood that not all examples may include such annular brackets 42.

In the example shown, each stator phase 22 is axially bracketed by a pair of annular brackets 42. Each stator phase 22 interfaces with at least one inner annular bracket 42a. In the example shown, there are the same number of inner annular brackets 42a as outer annular brackets 42b, though it is understood that not all examples are so limited.

Each array of axial returns 28 is formed by multiple axial returns 28 disposed annularly about the axis MA. In the example shown, each axial return 28 includes an end notch 44 on an axial end of the axial return 28. In the example shown, each axial return 28 includes a pair of end notches 44, with one disposed on each axial end of the axial return. The end notches 44 are oriented radially away from the rotor 12. The end notches 44 are open axially in a direction away from the stator phase 22 of that axial return 28 and are open radially in a direction away from air gap 30 and rotor 12. The end notches 44 are formed on an opposite radial side of the axial return 28 from the flux rings 24 of the same stator phase 22. The end notches 44 can extend fully across a circumferential width of the axial return 28.

FIG. 5 is a partially exploded view of stator 14. Stator phases 22 are shown. In the example shown, the stator 14 includes three stator phases 22, however different examples can include different number of stator phases 22. In the examples shown, the driving signals for the coil 26 of each stator phase 22 are generally 120-degrees electrically offset relative to the signals of the coils 26 of the other stator phases 22. Each stator phase 22 comprises two annular flux rings 24, which can include solid structure extending fully about the axis MA or can be formed by ring segments arrayed about the axis MA. Each flux ring 24 includes an array of teeth 40 disposed about the axis MA. The teeth 40 extend towards the rotor 12 and are configured to concentrate magnetic flux towards the rotor 12. Each stator phase 22 includes a coil 26 between the two annular rings of teeth 40. The coil 26 receives an A/C signal to generate electromagnetic flux which travels through the axial returns 28 and the flux rings 24 to concentrate the flux across the air gap 30 between the rotor 12 and the stator 14. Magnets 36 of the rotor 12 are then pushed and/or pulled by the electromagnetic flux to rotate the rotor 12 relative to the stator 14. Electrical current can be inducted in the coils 26 by rotation of the rotor 12 by an external force in the manner of a generator, in some examples.

Brackets 42 are configured to align stator phases 22 on the axis MA. Brackets 42 include inner annular brackets 42a and outer annular brackets 42b. At least some of brackets 42 can interface with multiple of stator phases 22 to align the stator phases 22 relative to each other for desired alignment to drive rotation of the rotor 12. The electrical driving signals are 120-degrees offset in the example shown and the stator phases 22 are rotationally offset relative to each other about the axis MA. In some other examples, the stator phases 22 can be rotationally aligned. In either example, brackets 42 are configured to locate stator phases 22 relative to each other and about the axis MA and can hold stator phases 22 relative to each other, such as for during the potting process.

Located between the stator phases 22 are inner annular brackets 42a. In the example shown, the inner annular brackets 42 are disposed directly axially between adjacent ones of the stator phases 22. Located on the ends of the stator 14 are outer annular brackets 42b. Outer annular brackets 42 are configured to interface with a single stator phase 22 located on the axial end of the stator 14. The outer annular brackets 42 can be considered to interface with the axially outermost stator phases 22.

Outer annular brackets 42b are configured to interface with the axially outer sides of the axially outer stator phases 22 of stator 14. In the example shown, each outer annular bracket 42b interfaces with a single stator phase 22 of the stator 14. Inner annular brackets 42a are disposed axially between adjacent stator phases 22. The inner annular brackets 42a are disposed axially within the stator 14. The inner annular brackets 42a are configured to interface with multiple stator phases 22. Each inner annular bracket 42a interfaces with two stator phases 22 in the example shown.

The annular brackets 42 are generally formed from polymer material. The annular brackets 42 can hold the axial returns 28 and position such axial returns 28 with respect to the flux rings 24. The annular brackets 42 can interface with the axial returns 28 to hold the axial returns 28 on the flux rings 24. In the example shown, the outer annular brackets 42b can each interface with a single array of axial returns 28 while the inner annular brackets 42a can each interface with multiple arrays of axial returns 28. The inner annular brackets 42a can interface with arrays of axial returns 28 of adjacent stator phases 22 to hold each array of axial returns 28 on the flux rings 24 of its respective stator phase 22. Each annular brackets 42 can interface with each axial return 28 forming an array of axial returns 28. It is understood that not all examples may include such annular brackets 42.

In the example shown, each stator phase 22 is axially bracketed by a pair of annular brackets 42. Each stator phase 22 interfaces with at least one inner annular bracket 42a. In the example shown, there are the same number of inner annular brackets 42a as outer annular brackets 42b, though it is understood that not all examples are so limited.

Each array of axial returns 28 is formed by multiple axial returns 28 disposed annularly about the axis MA. In the example shown, each axial return 28 includes an end notch 44 on an axial end of the axial return 28. In the example shown, each axial return 28 includes a pair of end notches 44, with one disposed on each axial end of the axial return. The end notches 44 are oriented radially away from the rotor 12. The end notches 44 are open axially in a direction away from the stator phase 22 of that axial return 28 and are open radially in a direction away from air gap 30 and rotor 12. The end notches 44 are formed on an opposite radial side of the axial return 28 from the flux rings 24 of the same stator phase 22.

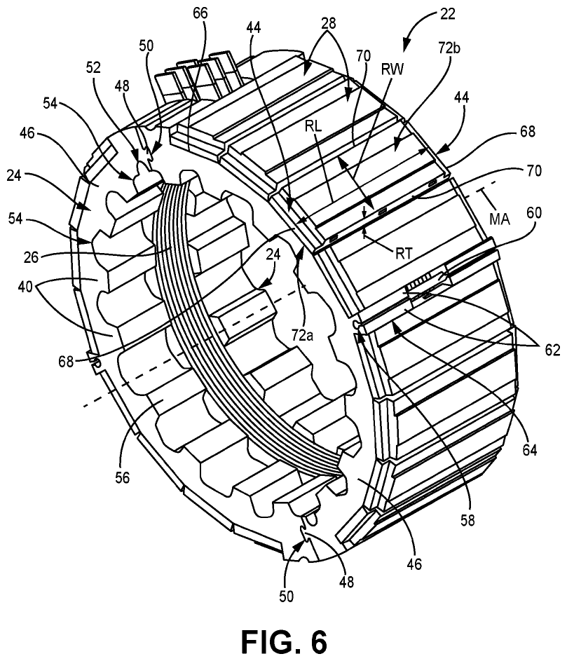

FIG. 6 is an isometric view of a stator phase 22. The other stator phases 22 of a stator 14 can be identical. The flux rings 24, coil 26, axial returns 28, and teeth 40 of the stator phase 22 are shown.

Each stator phase 22 includes a pair of flux rings 24 that each form an annular array of teeth 40 and includes a coil 26 located axially between the two annular arrays of teeth 40 of the pair of flux rings 24. The coil 26 is disposed directly axially between the flux rings 24. The coil 26 can axially overlap with the teeth 40 of each flux ring 24. An annular array of axial returns 28 radially overlap with the coil 26 and span between the pair of annular flux rings 24. The annular flux rings 24 and the axial returns 28 can be formed from stacks of steel laminations, among other options.

As shown, each flux ring 24 supports an annular array of teeth 40 about the axis MA. Each flux ring 24 is formed by multiple ring segments 46 that each extend partially about the axis MA. The multiple ring segments 46 can be fit end-to-end to form the flux ring 24. Each ring segment 46 supports multiple teeth 40, though it is understood that not all examples are so limited. A ring segment 46 can also be referred to as a tooth array segment. In the example shown, two ring segments 46 form each annular array of teeth 40, however a different number of ring segments 46 may form each annular array of teeth 40, or a single ring segment 46 may form all teeth 40 of a flux ring 24.

Each ring segment 46 includes a projection 48 and a receiver 50. The projections 48 and receivers 50 are formed at circumferential ends of the ring segments 46. In the example shown, each ring segment 46 includes a projection 48 on one circumferential end and a receiver 50 on an opposite circumferential end. Each receiver 50 is configured to receive a projection 48 of an adjacent ring segment 46 to align the ring segments 46. In some examples, a ring segment 46 may include two projections and/or two receivers, amongst other combinations.

Each ring segment 46 may be formed from a single stack of steel laminations, such that multiple teeth 40 are formed from the same stack of steel laminations. The ring segments 46 can be positioned relative to each other such that the ring segments 46 do not contact each other so as to not support electrical conduction between them. Potting material, such as epoxy, may fill in between the ring segments 46 and otherwise embed the various stator components. The potting material can fill into the portion of the receiver 50 not occupied by a projection 48 and between the material of the projection 48 and the material defining receiver 50.

Each ring segment 46 further includes one or more mounting slots 52. In the example shown, each ring segment 46 includes a single mounting slot 52. The mounting slot 52 is configured to receive a locator of an annular bracket 42, as discussed in more detail below. The locator can be formed as a post or other structure that projects axially to extend into the mounting slot 52. The mounting slot 52 is open on a radial side of the mounting slot 52 in the example shown. It is understood, however, that not all examples are so limited. For example, the mounting slot 52 could be open on only one or both axial ends and enclosed between those one or more end openings. As such, the mounting slot 52 can be formed as a bore in various examples.

The mounting slot 52 is formed on a radial side of ring segment 46 oriented towards the rotor 12. The mounting slot 52 is disposed on an opposite radial side of the flux ring 24 from the axial returns 28. The mounting slot 52 is oriented radially inward in the example shown. In the example shown, the mounting slot 52 is disposed in a trench 54 between circumferentially adjacent teeth 40 of the flux ring 24. In the example shown, the mounting slot 52 is not circumferentially bracketed by teeth 40 of a ring segment 46 in which mounting slot 52 is formed such that mounting slot 52 is not disposed circumferentially between teeth 40 of a single ring segment 46. Instead, the mounting slot 52 is circumferentially outward of all teeth 40 of the ring segment 46 in which the mounting slot 52 is formed. It is understood, however, that not all examples are so limited. The positioning of the mounting slot 52 circumferentially between teeth 40 maintains motor efficiency while providing a location for annular brackets 42 to interface with flux ring 24. The magnetic flux flows around the coil 26 and between the radially oriented faces of flux paired teeth 40 of the opposed flux rings 24. The mounting slot 52 is not in a direct pathway between the radial faces 56 of the teeth 40 and the axial returns 28. The radial face 56 of each tooth 40 is oriented towards and facing the rotor 12.

Flux rings 24 include alignment slots 58. Alignment slots 58 are configured to receive a pin 60. The pin 60 spans between the flux rings 24 to axially align the flux rings 24. The pins 60 align the flux rings 24 to align the teeth 40 of the opposed flux rings 24 to facilitate flux flow for interaction with magnetic fields of the rotor 12 for driving of the rotor 12. Each pin 60 spans between and extends into axially aligned alignment slots 58 on the opposed flux rings 24 of the stator phase 22.

In the example shown, the alignment slot 58 is open radially along at least a portion of the axial length of the alignment slot 58. In the example shown, the alignment slot 58 is radially open along a full axial length of the alignment slot 58. The alignment slot 58 being radially open along at least a portion of its length can facilitate flow of potting compound into the alignment slot 58 to fix the pin 60 in the alignment slot 58. The alignment slot 58 being radially open along at least a portion of its length can assist in press fitting of the pin 60 into the alignment slot 58 by allowing flexing of the arms 62 of the ring tab 64 defining the alignment slot 58. While the alignment slot 58 is radially open in the example shown, the alignment slot 58 could instead be radially closed along its axial length such that the alignment slot 58 just has one or two axial end openings. The pins 60 extending between ring segments 46 align the teeth 40 of the respective flux rings 24 of the same stator phase 22.

In the example shown, ring tabs 64 within which alignment slots 58 are formed project radially from a ring surface 66 of flux rings 24. The ring surface 66 is a radial side of flux ring 24 opposite the teeth 40. The ring surface 66 supports the axial returns 28. In the example shown, the ring surface 66 is faceted to support the individual axial returns 28. The ring surfaces 66 are oriented radially outward in the example shown as motor 10 is an inner rotator, though it is understood that not all examples are so limited. The ring tabs 64 project radially outward in the example shown. It is understood that in outer rotator examples the ring surfaces 66 can be oriented radially inward and the ring tabs 64 can project radially inward. The ring tabs 64 are disposed on a same radial side of the flux ring 24 as the axial returns 28. The ring tabs 64 are disposed on an opposite radial side of the flux ring 24 from the teeth 40.

Ring tabs 64 extend to circumferentially overlap with axial returns 28. Alignment slots 58 circumferentially overlap with axial returns 28. Pins 60 circumferentially overlap with axial returns 28. Ring tabs 64 are spaced radially from portions of flux rings 24 directing magnetic flux. Projecting ring tabs 64 radially from the main body portion of flux ring 24 positions pins 60 at locations to interface with and align flux rings 24 while not interfering with flux flow through flux rings 24.

The axial returns 28 span between flux rings 24 to radially overlap with the coil 26 and with each flux ring 24 of the stator phase 22. As shown, each axial return 28 includes end notches 44 and includes return ends 68, return sides 70, and return faces 72a, 72b. Return ends 68 are the axial ends of the axial return 28. Return sides 70 are the circumferential sides of the axial return 28. Return faces 72a, 72b are radially oriented. Return face 72a is oriented radially towards the rotor 12 and configured to interface with the flux rings 24 of the stator phase 22. Return face 72b is oriented radially away from the rotor 12. Return face 72b is oriented radially away from the flux rings 24 and coil 26.

Each axial return 28 is supported by both of the flux rings 24 of the stator phase 22. The axial returns 28 have width RW, length RL, and thickness RT. The width RW is taken between the opposed return sides 70 of the axial return 28. The return length RL is taken between the opposed return ends 68 of the axial return 28. The return thickness RT is taken between the opposed return faces 72a, 72b. The return thickness RT can be referred to as a radial thickness. The return face 72b is contoured in the example shown such that the return thickness RT of the axial return 28 varies across the width of the axial return 28.

End notches 44 extend into axial return 28. End notches 44 are configured to interface with retaining tabs 76 of an annular bracket 42. In the example shown, the axial returns 28 include end notches 44 formed in each return end 68. The end notches 44 are oriented axially. In the example shown, each end notch 44 is open radially, in one radial direction, and axially, in one axial direction.

The return face 72b is oriented radially away from the coil 26. The return face 72b is disposed on an opposite radial side of the axial return 28 from the coil 26. The return face 72b is oriented radially outward in the example shown. The return face 72b is contoured such that the axial return 28 has a varied return thickness RT at different locations across the return width RW of the axial return 28. In the example shown, the return face 72b is stepped and the tiers of stepped return face 72b are disposed circumferentially. It is understood, however, that return face 72b can be contoured in any desired manner (e.g., curved, etc.) such that the axial return 28 has a smaller return thickness RT at the return sides 70 than at a circumferential midpoint of the axial return 28. The return face 72b is disposed axially between the end notches 44. As discussed in more detail below, the contoured return face 72b facilitates tighter fitting of axial returns 28 relative to a motor housing about the stator 14, providing for a more compact motor 10 configuration.

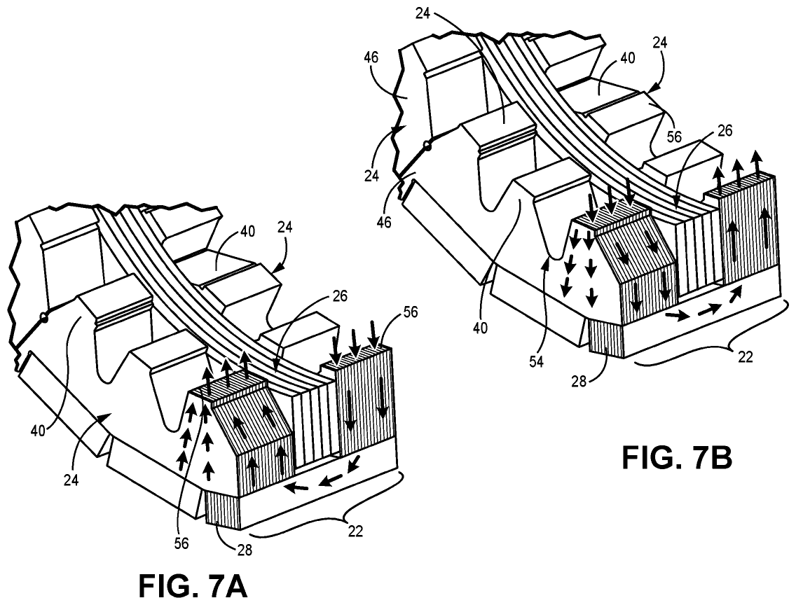

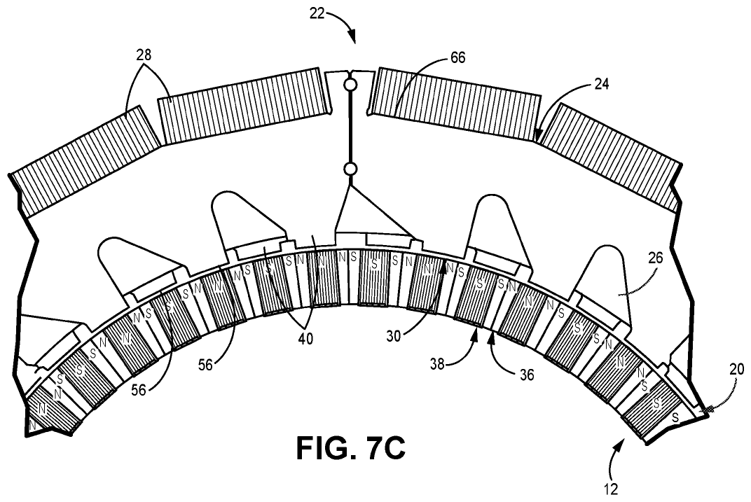

FIGS. 7A and 7B are isometric cross-sectional views of a portion of a stator phase 22 that demonstrate how flux circuits are formed through flux paired teeth 40 of a stator phase 22. FIG. 7C shows a detailed view of flux paired teeth 40 of a stator phase 22 interacting with concentrators 38 and permanent magnets 36 of the magnet array 20 of rotor 12.

Two opposite polarized states are shown between FIGS. 7A and 7B. As shown, the alternating flux path directions and polarizations are developed through the laminate of the flux rings 24 and axial returns 28. The alternating flux paths can be due to a sinusoidal signal delivered to each coil 26 to flux pair adjacent teeth 40 on opposite sides of the coil 26. These flux paths polarize the teeth 40 of one flux ring 24 relative to the teeth 40 of the other flux ring 24 to attract or repel the permanent magnets 36 of rotor 12 in synchrony with rotation of the rotor 12 so that flux paired ones of the teeth 40 attract a permanent magnet 36 as the permanent magnet 36 approaches and/or repel the permanent magnet 36 as the permanent magnet 36 passes.

Flux paired teeth 40 refer to respective closest pairs of teeth 40 of opposed flux rings 24. While a subset of teeth 40 are highlighted as flux paired ones of teeth 40 in FIGS. 7A and 7B, it is understood that these are examples and all teeth 40 of flux rings 24 similarly flux pair across the circular arrays of teeth 40.

Each tooth 40 is part of a similar flux circuit with its corresponding flux pair tooth 40 of the opposed flux ring 24. The flux paired teeth 40 pair generally axially with a tooth 40 of the opposing circular array of teeth 40, and not circumferentially to the neighbor tooth 40 of the same circular array of teeth 40 because all teeth 40 of a flux ring 24 will have the same polarity at any given time while all teeth 40 of the opposed flux ring 24 of the same stator phase 22 will have the opposite polarity at any given time. More specifically, each tooth 40 of a first flux ring 24 flux pairs with the closest teeth 40 of the opposed flux ring 24 on the other axial side of the coil 26. As shown in FIGS. 7A and 7B, a flux circuit is formed through flux paired teeth 40 such that the teeth 40 are respectively polarized, north and south.

Each tooth 40 narrows circumferentially as the tooth 40 extends radially away from the body of its flux ring 24. In the example shown, teeth 40 each narrow to a radial face 56 oriented towards rotor 12. The radial faces 56 can be planar and/or can be formed tangentially to a circle centered on common axis CA. The radial faces 56 provide a narrowed surface area relative to the body of the flux ring 24 and the axial returns 28. Teeth 40 narrow to concentrate flux towards rotor 12 to focus concentrated flux to a limited part of the rotor 12.

The flux is generated by coil 26. Specifically, an A/C signal is run through coil 26 which rapidly builds and collapses the magnetic field due to the current reversal of the AC signal through the coil 26. As shown, flux concentrating material of the flux rings 24 and axial returns 28 is wrapped around at least three sides of the coil 26. The lamination grain of the flux concentrating material is shown in FIGS. 7A and 7B. The lamination grain of the concentrators 38 and axial returns 28 can further be seen in FIG. 7C. Generally, flux flows with the grain, along the direction of lamination, as flux will generally follow the path of highest permeability and there is significant resistance to flux jumping from one layer of lamination to another layer of lamination. The lamination grain of the flux rings 24, including the teeth 40, is radially orientated while the lamination grain of the axial returns 28 is axially oriented. As such, the flux flows axially through the axial returns 28 and radially through the flux rings 24 and teeth 40 in a U-shape toward the rotor 12, the base of the U on an opposite side of the coil 26 from the rotor 12 and the legs of the U oriented towards the rotor 12. FIGS. 7A and 7B represent the reversal of the A/C signal and how the poles of the flux paired teeth 40 are switched.

The flux paired ones of teeth 40 are circumferentially offset from each other such that the teeth 40 of one flux ring 24 are not axially aligned with teeth 40 of the opposed flux ring 24. Being that the ends of the flux paired teeth 40 are not aligned axially, the flux circuit travels at least a limited distance circumferentially between the flux paired ones of teeth 40. Therefore, a cumulative flux circuit comprised of a plurality of flux paired teeth 40 can flow in a spiral pattern circumferentially through the teeth 40 and axial returns 28. It is noted that, while most flux flows between flux paired ones of teeth 40, the flux rings 24 permit flux flow between teeth 40 of the same flux ring 24, such that a limited amount of flux may skip a flux paired teeth 40 to the next-over tooth 40 of the same flux ring 24. As discussed in more detail below, flux rings 24 include a circumferential gap between adjacent ring segments 46 that is bridged only by potting compound. The circumferential gap prevents flux flow fully about the axis MA, thereby inhibiting the formation of eddy currents and facilitating efficient motor 12 operation.

FIG. 7C shows a detailed view of flux paired teeth 40 of the stator 14 interacting with concentrators 38 and permanent magnets 36 of the magnet array 20. The A/C signal through the coil 26 changes the direction of the electric current rapidly and thus changes the north-south polarity of the flux paired teeth 40 rapidly.

Concentrators 38 are disposed circumferentially between the permanent magnets 36. The laminate of the concentrators 38 does not have an inherent polarization, but due to the fixed position of concentrators 38 between magnet poles, the concentrators 38 assume an effective permanent polarization as indicated. Each concentrator 38 contacts two permanent magnets 36. Each concentrator 38 contacts the same pole of the two permanent magnets 36. For example, a concentrator 38 will be in contact with two south poles or in contact with two north poles. The concentrators 38 take on alternating north and south polarization on opposite sides of each permanent magnet 36 depending on the polarization adjacent to that concentrator 38. As indicated, each permanent magnet 36 is permanently polarized north and south on opposite sides of its short axis. The interleaved arrangement of permanent magnets 36 and concentrators 38 creates circumferential regions of oppositely polarized concentrators 38 and permanent magnet 36 poles.

The concentrators 38 route the magnetic flux from the permanent magnets 36 toward the stator 14. Flux circuits are completed across the air gap 30 between the stator 14 and rotor 12. The flux from the rotor 12 (specifically the permanent magnets 36) and the flux from the coil 26 (through the teeth 40) interact in the air gap 30, and the resulting flux shear forces rotation of the rotor 12. The flux of the present motor 10 has an orientation transverse to the axis of rotation MA. This is different from the radial flux orientation of traditional A/C and D/C brushless motors.

The flux generated by the stator 14 and acting on the rotor 12 is constantly changing due to both changing position of the permanent magnets 36 and concentrators 38 due to rotation of the rotor 12 as well as the change in polarization of the teeth 40 due to the change in the A/C signal through the coil 26. As such, the A/C signal routed through the coil 26 is synchronized with rotation of the rotor 12 to develop magnetic fields through the teeth 40 in time to the concentrators 38 approaching and departing the teeth 40 to simultaneously push and pull the permanent magnets 36 of the rotor 12 to provide the force that rotates the rotor 12. More specifically, the N-N and S-S interfaces repel while N-S interfaces attract, on approach and departure of alignment.

At least some of the respective A/C signals (e.g., sinusoidal or trapezoidal) delivered through the multiple coils 26 forming stator 14 are out of phase with respect to each other. In this way, the rotor 12 (along its axial length) more frequently has flux peaks acting on it, as compared to synchronizing the sinusoidal A/C signals, for a smoother torque profile acting on the rotor 12 along the axis of rotation of the rotor 12.

Traditional A/C induction motors use a plurality of discrete coils that form an array of coils that extend circumferentially around the axis of rotation of the rotor. Each coil represents a potential pole for acting on a magnet. The discrete coils arrayed circumferentially around the axis of rotation in a conventional A/C induction motor are out of phase with respect to each other. The discrete coils can interact with a small subset of the magnets at any given instance. The potential torque generated is proportional to the number of poles. The number of poles in such a motor is limited by the ability to fit discrete coils circumferentially around the axis of rotation within the motor. Coil windings can be made smaller, and the diameter of the stator can be made bigger, to accommodate more coils to support more poles, but this increases the size, weight, and cost of the motor and still has limits. Power can also be increased when the rotor is rotating at a relatively high rate, whereby more coil-magnet passes can be experienced per unit time. But such power increase requires the motor to operate at relatively high speed when some applications may desire low-speed output. Providing reduction gearing to reduce speed and increase torque to the desired high torque and low speed increases cost, weight, size, and friction.

Motors 10 according to the present disclosure are different from traditional A/C and D/C brushless motors. An aspect of the motor 10 is that it contains relatively few coils 26, only three in the illustrated examples. Unlike traditional A/C and D/C brushless motors, the coils 26 are formed from loops that extend entirely around the axis of rotation of the rotor 12. The axis of rotation of the rotor 12 extends through each loop (e.g., the center of each loop). Each coil 26 is annular, and the turns of each coil 26 are likewise annular, and the circular planar profile of the coil 26 and turns are orthogonal to the axis MA. The coils 26 do not include loops that generate flux that rotates the rotor 12 through which the axis MA does not extend. Instead of adding a coil for each pole as in traditional A/C induction motors, the flux rings 24 and axial returns 28 surrounding a single coil 26 channel the flux to a plurality of teeth 40 that flux pair across the stator phase 22 to create a plurality of poles from the single coil 26. As such, activating one coil 26 activates many poles, whereas in some traditional A/C and D/C brushless motors activation of one coil activates only one pole.

The high pole count eliminates or reduces the need for reduction gearing for outputs from motor 10, reducing off-center forces as well as reducing weight and friction, allowing for a more compact arrangement of motor 10. The motors 10 of the present disclose can generate high torque with a small package size, even at low speed. Therefore, gear reduction of a drive can be minimized or entirely excluded, providing savings on cost, size, weight, and friction.

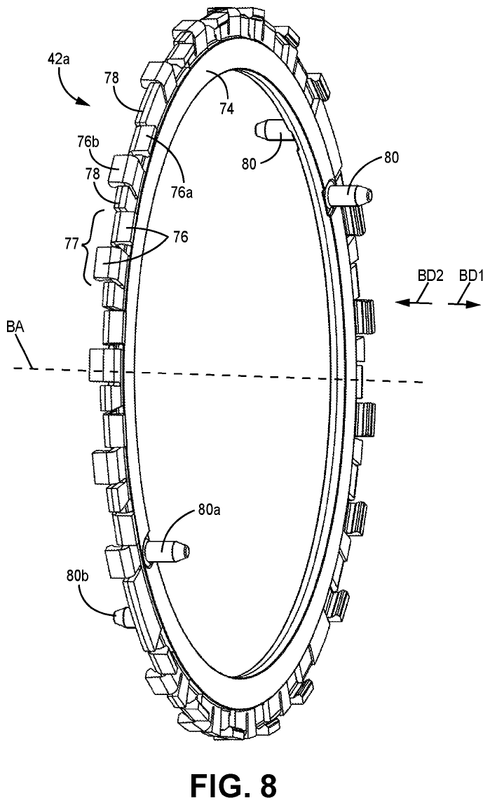

FIG. 8 is an isometric view of an inner annular bracket 42a. The inner annular bracket 42a is configured to be disposed axially between adjacent stator phases 22 of a stator 14. Bracket body 74 extends at least partially about axis BA, which axis BA can be coaxial with motor axis MA with inner annular bracket 42 assembled within stator 14. Bracket body 74 extends fully annularly about the axis BA in the example shown. Bracket body 74 has a circular inner radial surface. Bracket body 74 can have a continuous circular inner radial surface. Bracket body 74 can be considered to form a ring about the axis BA in the example shown. Annular bracket 42a is formed from non-ferric material such that annular bracket 42a does not interfere with and does not affect the magnetic flux. The annular bracket 42a can be formed from polymer, among other options.

Retaining tabs 76 project from bracket body 74. Retaining tabs 76 extend from a radial side of bracket body 74 facing away from rotor 12. In the example shown, retaining tabs 76 extend radially outward from the bracket body 74, though it is understood that not all examples are so limited. For example, retaining tabs 76 could extend radially inward in examples in which motor 10 is an outer rotator.

In the example shown, retaining tabs 76 project in both axial directions relative to the bracket body 74. A first subset of the retaining tabs 76 project in axial direction BD1 along axis BA and a second subset of the retaining tabs 76 project in axial direction BD2 along axis BA. A retaining tab 76a is indicated as one of the retaining tabs 76 of the first subset. A retaining tab 76b is indicated as one of the retaining tabs 76 of the second subset. The retaining tabs 76 that extend in opposite axial directions relative to axis BA are alternatingly disposed about the bracket body 74, in the example shown. Retaining tabs 76 can be disposed in pairs 77 about the bracket body 74. In the example shown, each pair 77 of retaining tabs 76 includes a retaining tab 76 from the first subset and a retaining tab 76 from the second subset. Each pair 77 of retaining tabs 76 can be referred to as a tab pair. As such, each pair 77 of retaining tabs 76 includes one retaining tab 76 that extends axially outward of the bracket body 74 in a first axial direction BD1 and a second retaining tab 76 that extends axially outward of the bracket body 74 in a second axial direction BD2.

A count of the retaining tabs 76 of each subset of retaining tabs annular bracket 42b can be the same as a count of the axial returns 28 of the stator phase 22 that that subset of retaining tabs 76 interfaces with. As such, each retaining tab 76 can interface with a single axial return 28 and each axial return 28 can interface with a single retaining tab of annular bracket 42a. It is understood that each axial return 28 can interface with two retaining tabs 76, one on each axial end, but that each axial return 28 still interfaces with a single retaining tab 76 from each annular bracket 42 that interfaces with the axial return 28.

The retaining tabs 76 of the first and second subsets of retaining tabs 76 project in opposite axial directions to interface with and hold respective axial returns 28 of adjacent stator phases 22. The retaining tabs 76 of the first subset extend in direction BD1 and the retaining tabs 76 of the second subset extend in direction BD2. In the example shown, the retaining tabs 76 are configured to engage the axial returns 28 at the end notches 44 formed at the axial ends of the axial returns 28, though it is understood that not all examples are so limited. The retaining tabs 76 engaging the axial returns 28 at end notches 44 provides for a more radially compact annular bracket 42a such that annular bracket 42a may not extend radially outward of axial returns 28. Such a configuration reduces the size of the stator 14 allowing for closer fitting of a housing to the axial returns 28, which can provide for more efficient heat transfer and cooling for motor 10.

In the example shown, inner annular bracket 42a includes body tabs 78 are interspersed with the retaining tabs 76. In the example shown, a pair of retaining tabs 76 is disposed between circumferentially adjacent body tabs 78. The pair of retaining tabs 76 between each body tab 78 includes one retaining tab 76 of each of the first and second subsets, with one retaining tab 76 of the pair extending in axial direction BD1 and one retaining tab 76 of the pair extending in axial direction BD2. The paired retaining tabs 76 thus extend in opposite axial directions.

Body tabs 78 do not extend axially relative to the bracket body 74 in the example shown. The body tabs 78 do not extend to retain components of a stator phase 22 in the example shown. Body tabs 78 project away from bracket body 74 in the same radial direction as retaining tabs 76 project away from bracket body 74. Body tabs 78 are circumferentially aligned with retaining tabs 76 to circumferentially overlap with retaining tabs 76. Body tabs 78 can provide structural stability to annular bracket 42a and inhibit contact damage to retaining tabs 76 prior to or during installation in stator 14.

Locators 80 project from annular bracket 42a. In the example shown, the locators 80 project outward from the bracket body 74. In the example shown, the locators 80 extend axially from the bracket body 74. The locators 80 are projections that extend from bracket body 74 and that are configured to interface with a flux ring 24. The projections are cylindrical along at least a portion of their length, in the example shown. The locators 80 are configured to extend into mounting slots 52 of the flux rings 24 of adjacent stator phases 22 to align the teeth 40 of the adjacent stator phases 22 relative to each other. The relative alignment of teeth 40 between phases facilitates driving of rotor 12 with the electrically offset signals to each stator phase 22. The locators 80 are formed as posts in the example shown.

In the example shown, annular bracket 42a includes a first subset of locators 80 that extend in first axial direction BD1 and a second subset of locators 80 that extend in second axial direction BD2. A locator 80a is indicated as one of the locators 80 of the first subset. A locator 80b is indicated as one of the locators 80 of the second subset. Locators 80 of the first subset of locators 80 extend in axial direction BD1 from bracket body 74 and locators 80 of the second subset of locators 80 extend in axial direction BD2 from bracket body 74. In the example shown, the locators 80 are axially straight between a base of the locator 80 at bracket body 74 and a distal end of locator 80 spaced from bracket body 74. It is understood that in some examples locators 80 can extend axially and radially.

Locators 80 of the first subset of locators 80 are circumferentially offset from locators 80 of the second subset of locators 80, in the example shown. Locators 80 of the first subset do not axially overlap with locators 80 of the second subset in the example shown. Locators 80 of the first subset do not circumferentially overlap with locators 80 of the second subset in the example shown. In the example shown, locators 80 of the first subset are disposed at a same radial distance from axis BA as locators 80 of the second subset. The locators 80 of the first and second subsets being the same radial distance from axis BA allows annular bracket 42 to be installed with locators 80 of the first subset facing in either axial direction AD1, AD2 along the motor axis MA. The locators 80 of the first subset being circumferentially offset from the locators 80 of the second subset facilitates annular bracket 42a circumferentially aligning adjacent stator phases 22 relative to each other to facilitate provision of the electrically offset driving signals (e.g., 120-degrees electrically offset) to the adjacent stator phases 22.

The locators 80 of each subset can be arrayed evenly about the axis BA. In the example shown, each subset of locators 80 includes a pair of locators 80. The annular bracket 42a includes the same number of locators as ring segments 46 that form a flux ring 24. In the example shown, the pair of locators 80 that form the first subset of locators are disposed on opposite circumferential sides of the bracket body 74. The pair of locators 80 of the first subset can be disposed 180-degrees from each other about the axis BA. In the example shown, the pair of locators 80 that form the second subset of locators are disposed on opposite circumferential sides of the bracket body 74. The pair of locators 80 can be disposed 180-degrees from each other about the axis BA. In the example shown, the locators 80 of the first and second subset that are circumferentially closest to each other and on the opposite axial sides of the annular bracket 42a are disposed such that no retaining tabs 76 are disposed circumferentially between those locators 80.

While annular bracket 42a is shown as including a pair of locators 80 for each subset of locators, it is understood that other configurations are possible. For example, annular bracket 42a can includes three, four, five, or more locators 80 in each subset. In some examples, a count of the locators 80 within a subset of locators of annular bracket 42a can be the same as a count of the ring segments 46 forming the flux ring 24 interfacing with those locators 80. In such an example, each ring segment 46 can interface with a single locator 80. For example, if a flux ring 24 includes three ring segments 46, then the subset of locators 80 interfacing with that flux ring 24 can include three locators 80 with one interfacing with each ring segment 46. In some examples, each ring segment 46 can include more than one mounting slot 52 and annular bracket 42a can include multiple locators 80 interfacing with each ring segment 46. For example, if a flux ring 24 includes two ring segments 46 and each ring segment 46 includes two mounting slots 52, then the subset of locators 80 interfacing with that flux ring 24 can include four locators 80. In the example shown, annular bracket 42 includes the same count of locators 80 in each subset; it is understood, however, that in other examples the count of locators 80 can differ between the subsets.

Annular bracket 42a provides significant advantages. The retaining tabs 76 of the annular bracket 42 interface with an annular array of axial returns 28 to hold the axial returns 28 on a flux ring 24. The annular bracket 42a holds the axial returns 28 in place relative to the flux ring 24 such as during potting of the stator 14 to maintain the positions of those axial returns 28 during the potting process. Such retention and holding maintains the axial returns 28 in contact with flux rings 24, ensuring formation of a flux circuit between the flux ring 24 and axial returns 28. The annular bracket 42a holds axial returns 28 of two adjacent stator phases 22 on the flux rings 24 of the adjacent stator phases 22.

Annular bracket 42a interfaces with flux rings 24 to align the flux rings 24 of adjacent stator phases 22. Locators 80 extend to interface with a first flux ring of a first stator phase 22 and with a second flux ring 24 of a second stator phase 22 that is axially adjacent to the first stator phase 22. The locators 80 interface with both flux ring 24 to align the stator phases 22 relative to each other about the axis MA. The annular bracket 42a interfacing with the flux rings 24 aligns the stator phases 22 for the provision of the electrically offset driving signals.

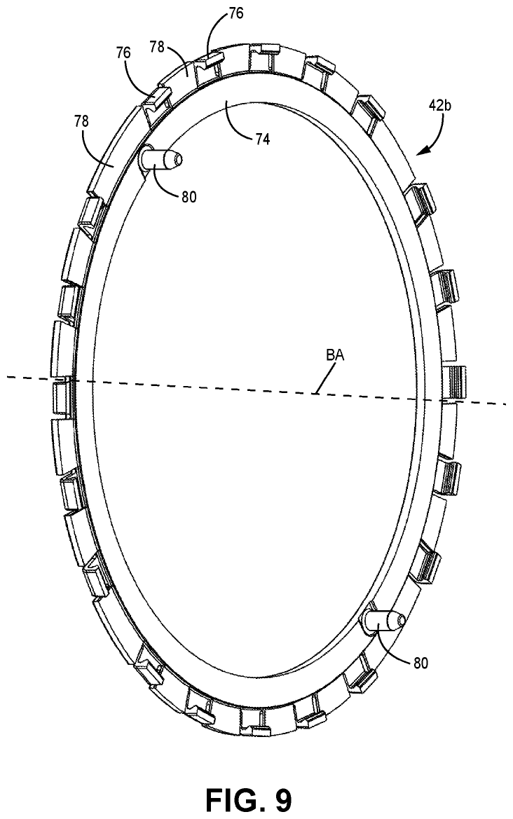

FIG. 9 is an isometric view of outer annular bracket 42b. The outer annular bracket 42b includes retaining tabs 76 and locators 80. The retaining tabs 76 and locators 80 of the annular bracket 42b extend in a single axial direction away from the bracket body 74 along the body axis BA. The outer annular bracket 42b is configured to be disposed on an outer axial end of the stator 14. The outer annular bracket 42b is configured to interface with a single stator phase 22 of the stator 14, unlike the inner annular bracket 42a (best seen in FIG. 8). The retaining tabs 76 and the one or more locators 80 interface with the axial returns 28 and the ring segments 46, respectively, similar to the retaining tabs 76 and locators 80 of the inner annular bracket 42. Annular bracket 42b is formed from non-ferric material such that annular bracket 42b does not interfere with and does not affect the magnetic flux. The annular bracket 42b can be formed from polymer, among other options. Bracket body 74 extends at least partially about axis BA, which axis BA can be coaxial with motor axis MA with outer annular bracket 42b assembled with stator 14. Bracket body 74 extends fully annularly about the axis BA in the example shown. Bracket body 74 has a circular inner radial surface. Bracket body 74 can have a continuous circular inner radial surface. Bracket body 74 can be considered to form a ring about the axis BA in the example shown.

Retaining tabs 76 project from bracket body 74. Retaining tabs 76 extend from a radial side of bracket body 74 oriented away from the rotor 12. In the example shown, retaining tabs 76 extend radially outward from the bracket body 74 and away from axis BA, though it is understood that not all examples are so limited. For example, retaining tabs 76 could extend radially inward in examples in which motor 10 is an outer rotator. Retaining tabs 76 project axially relative to bracket body 74. In the example shown, each retaining tab 76 projects in the same axial direction relative to the bracket body 74. The retaining tabs 76 project in a single axial direction to interface with and hold axial returns 28 of a single stator phase 22. In the example shown, the retaining tabs 76 are configured to engage the axial returns 28 at the end notches 44 formed at the axial ends of the axial returns 28. A count of the retaining tabs 76 of annular bracket 42b can be the same as a count of the axial returns 28 of the stator phase 22 that annular bracket 42b interfaces with. As such, each retaining tab 76 can interface with a single axial return 28 and each axial return 28 can interface with a single retaining tab. It is understood that each axial return 28 can interface with two retaining tabs 76, one on each axial end, but that each axial return 28 still interfaces with a single retaining tab 76 from each annular bracket 42 that interfaces with the axial return 28.

In the example shown, annular bracket 42b includes body tabs 78 that are interspersed with retaining tabs 76. In the example shown, a single retaining tab 76 is disposed between circumferentially adjacent body tabs 78. Body tabs 78 do not extend to retain components of a stator phase 22. Body tabs 78 do not extend axially outward of bracket body 74 in the example shown. Body tabs 78 project away from bracket body 74 in the same radial direction as retaining tabs 76 and are circumferentially aligned with retaining tabs 76. Body tabs 78 circumferentially overlap with retaining tabs 76. Body tabs 78 can provide structural stability to annular bracket 42 and inhibit contact damage to retaining tabs 76 prior to or during installation in stator 14.

Locators 80 project from annular bracket 42b. In the example shown, the locators 80 project outward from the bracket body 74. In the example shown, the locators 80 extend axially from the bracket body 74. The locators 80 are projections that extend from bracket body 74, in the example shown. The projections are cylindrical along at least a portion of their length, in the example shown. The locators 80 are configured to extend into mounting slots 52 of a flux ring 24 of a single stator phase 22. The locators 80 are formed as posts in the example shown. The locators 80 are configured to extend into mounting slots 52 of a flux ring 24.

The annular bracket 42b is disposed at an axial end of stator 14 such that annular bracket 42 is configured to interface with a single flux ring 24 of the stator 14. The annular bracket 42b can align the axially outer flux ring 24, and thus the axially outer stator phase 22, on the motor axis MA. For example, the annular bracket 42b can align the flux ring 24 within a mandrel utilized during potting of the stator 14. The annular bracket 42b can position the axially outermost flux ring 24 of the stator 14 within the mandrel with other components of stator 14 then aligned with that axially outermost flux ring 24. Such as configuration can facilitate potting into a blind hole. In the example shown, the locators 80 are axially straight between a base of the locator 80 at bracket body 74 and a distal end of locator 80 spaced from bracket body 74. It is understood that in other examples, locators 80 can extend axially and radially.

In the example shown, annular bracket 42b includes a pair of locators 80 that extend in a single axial direction relative to body axis BA. While annular bracket 42 is shown as including a pair of locators 80, it is understood that other configurations are possible. For example, annular bracket 42 can includes three, four, five, or more locators 80. In some examples, a count of the locators 80 of annular bracket 42 can be the same as a count of the ring segments 46 forming flux ring 24. In such an example, each ring segment 46 can interface with a locator 80. For example, if a flux ring 24 includes three ring segments 46, then the locators 80 interfacing with that flux ring 24 can include three locators 80 with one interfacing with each ring segment 46. In some examples, each ring segment 46 can include more than one mounting slot 52 and annular bracket 42b can include multiple locators 80 interfacing with each ring segment 46. For example, if a flux ring 24 includes two ring segments 46 and each ring segment 46 includes two mounting slots 52, then annular bracket 42b can include four locators 80.

In the example shown, annular bracket 42b includes a pair of locators 80. The locators 80 are disposed on opposite sides of the bracket body 74. The locators 80 can be disposed 180-degrees from each other about the axis BA in the example shown. In the example shown, the locators 80 are disposed such that no retaining tabs 76 are disposed directly radially outward or directly radially inward of the locator 80 relative to axis BA. Annular bracket 42b provides significant advantages. The retaining tabs 76 of the annular bracket 42b interface with an annular array of axial returns 28 to hold the axial returns on a flux ring 24. The annular bracket 42b holds the axial returns 28 in place relative to the flux ring 24 such as during potting of the stator 14 to maintain the positions of those axial returns 28 during the potting process. Such retention and holding maintains the axial returns 28 in contact with a flux ring 24, ensuring formation of a flux circuit between the flux ring 24 and axial returns 28.

Annular bracket 42b interfaces with flux rings 24 to align a single stator phase 22. Locators 80 extend to interface with a first flux ring 24 of a first stator phase 22, the first stator phase 22 being an axially outer stator phase 22 of the stator 14. The annular bracket 42b interfaces with the axially outermost flux ring 24 of the stator 14. The annular bracket 42b can be located within a potting container, such as a mandrel, and hold the axially outer flux ring 24 in a desired position about the motor axis MA. The locators 80 interface with the axially outer flux ring 24 to align the stator phase 22 that includes that flux ring about the axis MA.

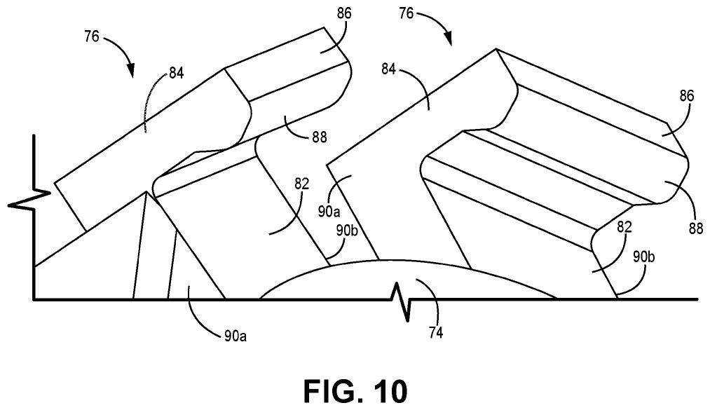

FIG. 10 is an enlarged isometric view showing retaining tabs 76 of an annular bracket 42. While retaining tabs 76 are shown for an outer annular bracket 42b, as all retaining tabs 76 extend in the same axial direction, it is understood that the retaining tabs 76 are representative of retaining tabs 76 for either an outer annular bracket 42b or an inner annular bracket 42a. Each retaining tab 76 can be configured identically to the other retaining tabs 76 of the same annular bracket 42. Body tabs 78 are not shown in FIG. 10 for clarity. Each retaining tab 76 can be configured identically as the other retaining tabs 76 of a same subset of bracket tabs or as all other bracket tabs of the annular bracket 42 (e.g., all retaining tabs 76 of a first subset of bracket tabs of an annular bracket 42 can be configured the same as each other, all retaining tabs 76 of a second subset of bracket tabs of an annular bracket 42 can be the same, or all retaining tabs 76 of all subsets of bracket tabs of an annular bracket 42 can be the same). The retaining tabs 76 can be considered to be L-shaped, though it is understood that the disclosure is not so limited and other configurations are possible.

Retaining tab 76 includes tab body 82 that extends from bracket body 74. The tab body 82 extends radially away from the bracket body 74. Tab body 82 projects from a radially oriented surface of the bracket body 74. The tab body 82 extends from a radial side of bracket body 74 oriented away from the rotor 12. In the example shown, the tab body 82 extends directly radially from the bracket body 74, though it is understood that not all examples are so limited. For example, tab body 82 can be canted to extend radially and axially away from bracket body 74. In the example shown, tab body 82 extends radially outward from bracket body 74, though not all examples are so limited. For example, tab body 82 can extend radially inward from bracket body 74 in examples in which motor 10 is an outer rotator.

Tab extension 84 extends from tab body 82. Tab extension 84 projects axially away from tab body 82. Tab extension 84 extends axially beyond an axial face of the bracket body 74. As such, a distal end 86 of tab extension 84 is spaced axially from the axial face of the bracket body 74. Tab extension 84 extends from a radial end of the tab body 82 opposite a base end of the tab body 82 that interfaces with bracket body 74. Tab extension 84 can extend directly axially outward from tab body 82 or can be canted to extend radially and axially. For example, tab extension 84 can extend axially and radially and be configured to flex when engaging with an axial return 28 to exert a spring force on the axial return 28.

Tab extension 84 is configured to interface with an axial return 28 to hold the axial return on a flux ring 24. In the example shown, tab extension 84 is configured to interface with the axial return 28 at an end notch 44 of the axial return 28. Tab extension 84 is configured to extend into the end notch 44 such that the retaining tab 76 radially overlaps with the axial return 28 to hold the axial return 28 on a flux ring 24. Retaining tab 76 further axially overlaps with the axial return 28 that the retaining tab 76 engages with. The end notch 44 being recessed from the return face 72b of the axial return 28 positions the portion of retaining tab 76 that radially overlaps with the axial return 28 to also axially overlap with the axial return 28. In the example shown, the tab extension 84 can both radially and axially overlap with the axial return 28 that the tab extension 84 engages.

Detent 88 is formed on tab extension 84. Detent 88 is disposed proximate the distal end 86 of the tab extension 84. Detent 88 forms a radial projection of tab extension 84. Detent 88 is configured to engage with an axial return 28. Detent 88 can snap over a lip formed at an axially outer portion of end notch 44 to provide a snap-fit connection between annular bracket 42 and the annular array of axial returns 28. It is understood that not all examples include a lip at an outer edge of the end notch 44. The detent 88 extends radially closer to the bracket body 74 than the body of tab extension 84.

Detent 88 is formed as a bulge in the example shown. Detent 88 is sloped on both axial sides of detent 88. The sloped axial faces of detent 88 can facilitate sliding of detent 88 onto an axial return 28. In the example shown, detent 88 extends fully across a circumferential width of retaining tab 76. Detent 88 extends between a first tab side 90a of retaining tab 76 and a second tab side 90b of retaining tab 76. The tab sides 90a, 90b can be considered to form circumferential sides of the retaining tab 76. It is understood that in some examples, detent 88 can span only a portion of the circumferential width of the tab extension 84. Detent 88 can, in some examples, be formed as a discrete projection (e.g., hemispherical, pyramidal, among other options) extending radially from tab extension 84. Retaining tab 76 provides significant advantages. Each retaining tab 76 projects axially outward relative to bracket body 74 to radially overlap with an axial return 28. Each retaining tab 76 can interface with a single axial return 28 of the array of axial returns 28. The retaining tab 76 holds the axial return 28 on a flux ring 24. The retaining tab 76 can exert a radial biasing force on the axial return 28 to bias the axial return 28 into contact with the flux ring 24. The retaining tab 76 holds the axial return 28 so that a flux pathway is maintained through axial return 28 and flux ring 24 and retaining tab 76 prevents separation of the axial return 28 and flux ring 24 during assembly, such as during potting of the stator 14.

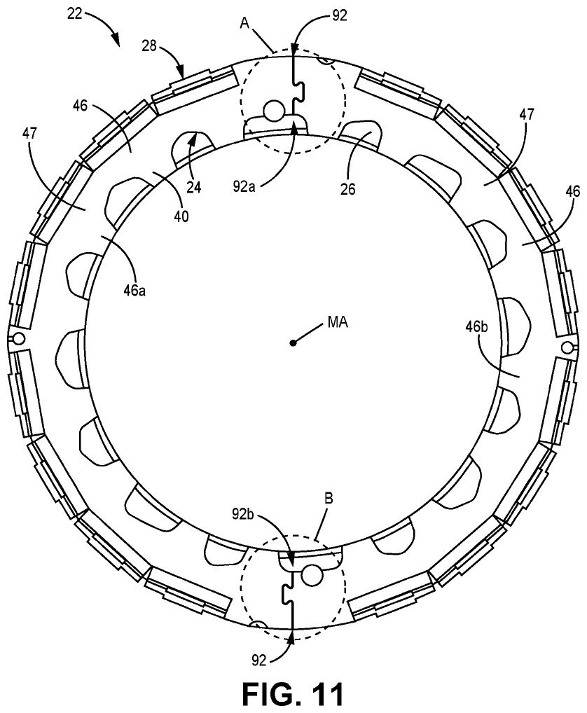

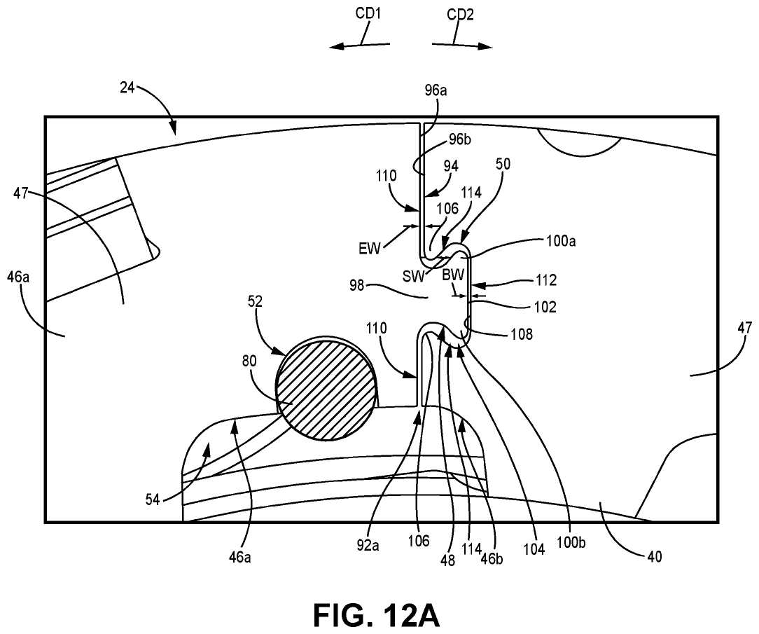

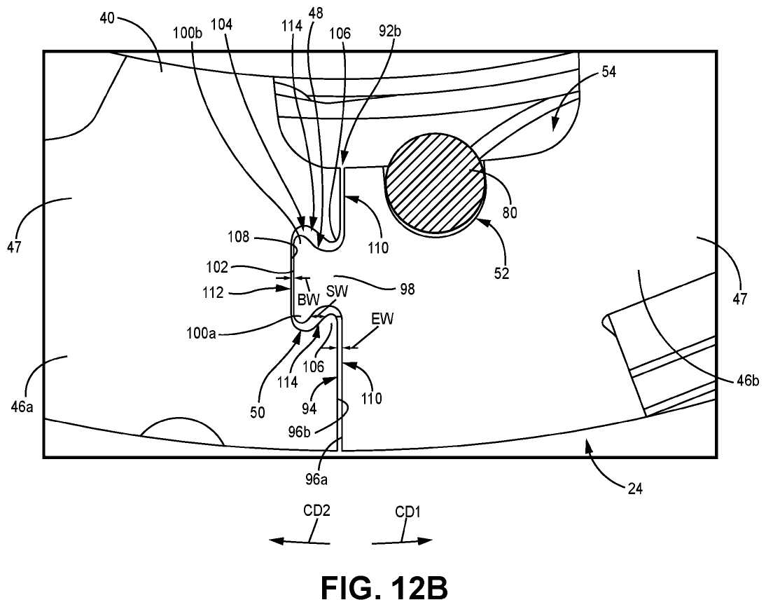

FIG. 11 is an end view of a portion of a stator phase 22. FIG. 12A is an enlarged view of a first interface 92a between ring segments 46a, 46b of a flux ring 24. FIG. 12B is an enlarged view of a second interface 92b between ring segments 46a, 46b of a flux ring 24. Interfaces 92a, 92b are referred to collectively herein as “interface 92” or “interfaces 92.” FIGS. 11-12B are discussed together and with continued reference to FIGS. 1-10. The interfaces 92 between adjacent ring segments 46 of a flux ring 24 are shown. A flux ring 24 is formed by at least one ring segment 46. In the example shown, flux rings 24 are formed by multiple ring segments 46 that are assembled together to form a flux ring 24. In the example shown, flux ring 24 is formed by a pair of ring segments 46a, 46b. Each ring segment 46 supports at least one tooth 40 of the annular array of teeth 40 of the flux ring 24. The multiple ring segments 46 of a flux ring 24 are aligned circumferentially to circumferentially overlap. The multiple ring segments 46 can have a common base configuration such that each ring segment 46 is the same as the other ring segments 46 forming the flux ring 24. In such an example, the ring segments 46 can be considered to have the same base configuration. For example, a single stamp can be used to form each lamina of each ring segment 46, the multiple laminas stacked together to form each ring segment 46 and the ring segments 46 fit end-to-end to form the flux ring 24.

As shown, the ring segments 46a, 46b come together at interfaces 92. Ring segments 46a, 46b radially overlap with each other at each interface 92. A portion of one of the ring segments 46 extends circumferentially to radially overlap with the adjacent ring segment 46. The radial overlap between ring segments 46a, 46b can provide increased stiffness to flux ring 24 as compared to ring segments that do not radially overlap. Providing greater stiffness to flux ring 24 allows for formation of a radially smaller air gap 30, providing improved efficiency for motor 10.

The ring segments 46a, 46b are configured such that a circumferential gap 94 is formed at at least one location about the flux ring 24 between interfacing ring segments 46. The circumferential gap 94 prevents formation of a circuit in flux ring 24, preventing shorting. The circumferential gap 94 means that there is no connected metallic structure of flux ring 24 that extends fully about the axis MA. Instead, at least one circumferential gap 94 is formed between metallic structure of flux ring 24 and fully axially through flux ring 24, which may be filled by potting compound, that prevents a full metallic circle about the axis MA formed by flux ring 24. The at least one circumferential gap 94 is formed between adjacent ring segments 46 of the plurality of ring segments 46 forming the flux ring 24 such that the flux ring 24 does not include a common metallic link fully about the axis MA.

In the example shown, metallic portions of flux ring 24 are disposed to radially overlap such that flux ring 24 does not include a circumferential gap 94 that extends straight between the inner and outer radial sides of the flux ring 24. The circumferential gap 94 extends fully through flux ring 24 between the two radial sides of the flux ring 24 such that the circumferential gap 94 is open through the outer radial side of flux ring 24, through the inner radial side of flux ring 24, and between the inner and outer radial sides of flux ring 24. As such, each location circumferentially about the motor axis MA radially overlaps with metallic structure of the flux ring 24, but such metallic structure does not form a common metallic link fully about the axis MA.

In some examples, a ring segment 46 can contact an adjacent ring segment 46 on one circumferential end of the ring segment 46 but can be out of contact with an adjacent ring segment 46 (the same or a different adjacent ring segment 46) on an opposite circumferential end of the ring segment 46. As such, while flux ring 24 can be formed from multiple ring segments 46, flux ring 24 may include only a single circumferential gap 94 fully radially and axially through flux ring 24. It is understood, however, that ring segments 46 may be disposed such that circumferential gaps 94 are formed on both circumferential sides of a single ring segment 46 or all ring segments 46 of the flux ring 24.

Each ring segment includes a segment body 47 that extends between the circumferential ends 96a, 96b of the ring segment 46. The teeth 40 extend radially from the segment body 47. In the example shown, each ring segment 46 includes a projection 48 and a receiver 50. The projections 48 and receivers 50 are formed on circumferential ends 96 of the ring segments 46. In the example shown, each ring segment 46 includes a projection 48 on one circumferential end 96a and a receiver 50 on an opposite circumferential end 96b. Each receiver 50 is configured to receive a projection 48. The projection 48 extending into the receiver 50 can align the ring segments 46 relative to each other. In some examples, a ring segment 46 may include two projections and/or two receivers, amongst other combinations. For example, the each of the multiple projections 48 of a single ring segment 46 can each extend into a corresponding receiver 50 of the multiple receivers 50 of the adjacent ring segment 46. In some examples, multiple protrusions can extend from a ring segment 46 to form a projection 48 and the multiple protrusions can extend into a single receiver 50.

Each ring segment 46 may be formed from a single stack of laminations, such that multiple teeth 40 are formed from the same stack of laminations. The ring segments 46 can be positioned relative to each other such that the ring segments 46 do not contact each other so as to not support electrical conduction between them. Potting material, such as epoxy, may fill in between the ring segments 46, such as within the one or more circumferential gaps 94, and otherwise embed the various stator components. The potting material can fill into the portion of the receiver 50 not occupied by a projection 48 and between the material of the projection 48 and the material defining receiver 50.

Each ring segment 46 includes circumferential ends 96a, 96b. The interface 92 is formed between opposing circumferential ends 96a, 96b of adjacent ring segments 46. Circumferential end 96a of ring segment 46a is shown in FIG. 12A and circumferential end 96b of ring segment 46b is shown in FIG. 12A. Circumferential end 96b of ring segment 46a is shown in FIG. 12B and circumferential end 96a of ring segment 46b is shown in FIG. 12B. In the example shown, flux ring 24 is formed from a pair of ring segments 46a, 46b that interface with each other at two locations about the axis MA. It is understood that flux ring 24 can be formed from more or fewer than two ring segments 46, such as by one, three, four, five, or more ring segments 46.

In some examples, flux ring 24 can be formed by a single ring segment that includes the overlapping projection 48 and receiver 50, such that a single interface 92 is formed. For example, the laminas that form the flux ring 24 can be shaped to include the projection 48 already extending within, but not contacting the material defining, the receiver 50. The stacked laminas can thus define a projection 48 and receiver 50 for a flux ring 24 formed by a single ring segment 46. Such a flux ring 24 formed by a single ring segment 46 includes a single circumferential gap 94 that spaces the two circumferential ends of that single ring segment 46 from each other to prevent conduction fully about the axis MA.

In some examples, flux ring 24 can be formed by more than two ring segments 46 such that flux ring 24 includes more than two interfaces 92. Flux ring 24 can include the same number of interfaces 92 as ring segments 46. In examples with more than two ring segments 46, each ring segment 46 is circumferentially adjacent to two different ring segments 46 such that each ring segment 46 can form a first interface 92 with a first separate and adjacent ring segment 46 and a second interface 92 with a second separate and adjacent ring segment 46.

In the example shown, projection 48 and receiver 50 mate to overlap radially and such that projection 48 is circumferentially overlapped by the ring segment 46 defining the receiver 50 in both circumferential directions CD1 and CD2 about the motor axis MA. The projection 48 is bracketed by the receiver 50 in the example shown such that the material defining the receiver 50 is directly circumferentially outward from the projection 48 in both circumferential directions CD1, CD2. It is understood, however, that not all examples are so limited. For example, projection 48 can extend into receiver 50 such that the ring segments 46 radially overlap but the projection 48 is not bracketed on both circumferential sides by the receiver 50 into which the projection 48 extends.

In the example shown, projection 48 includes neck 98, catches 100a, 100b, and projection base 102; receiver 50 defines receiving cavity 104, and receiving cavity 104 is defined by retainers 106 and cavity base 108 of receiver 50. The projection 48 and receiver 50 can be considered to form a dovetail interface in the example shown.

A projection 48 extends from circumferential end 96a of each ring segment 46a, 46b. A receiver 50 is formed in circumferential end 96b of each ring segment 46. FIGS. 12A and 12B show the two interfaces 92a, 92b between the pair of ring segments 46a, 46b that form the flux ring 24. Circumferential end 96a and circumferential end 96b of circumferentially adjacent ring segments 46 oppose each other and circumferentially overlap with each other. In the example shown, no metallic structure of flux ring 24 formed separate from the adjacent ring segments 46a, 46b is disposed directly circumferentially between the adjacent ring segments 46. It is understood that potting compound can fill within the circumferential gap 94 directly circumferentially between the adjacent ring segments 46.

Projection 48 extends into receiver 50 and is disposed within receiver 50 such that ring segments 46a, 46b radially and circumferentially overlap each other. The receiver 50 radially overlaps with the projection 48 radially inward of the projection 48 and radially outward of the projection 48. While ring segments 46a, 46b radially and circumferentially overlap, ring segments 46a, 46b are not in contact at both interfaces 92a, 92b, though they may be in contact at one of interfaces 92a, 92b, such that a common metallic link is not formed fully about the axis MA.

Neck 98 extends through the radial gap formed between retainers 106 to extend into receiving cavity 104. Catches 100a, 100b project from neck 98. Catches 100a, 100b are disposed within receiving cavity 104. Catch 100a projects radially outward and away from motor axis MA. Catch 100a projects away from teeth 40. Catch 100a projects towards axial returns 28. Catch 100b projects radially inward and towards the motor axis MA. Catch 100b projects towards teeth 40. Catch 100b projects away from axial returns 28.

Catches 100a, 100b project away from neck 98 to circumferentially overlap with retainers 106. Each catch 100a, 100b circumferentially overlaps with one of retainers 106. The overlap between catches 100a, 100b and retainers 106 prevents ring segments 46 from begin pulled off of each other. The catches 100a, 100b are circumferentially bracketed by material of the receiver 50. In the example shown, each catch 100a, 100b is circumferentially overlapped by a retainer 106 and by cavity base 108. Each catch 100a, 100b is also radially overlapped by material defining receiver 50. Each catch 100 is circumferentially overlapped by a retainer 106 such that the retainer 106 is directly circumferentially between the catch 100 and the circumferential end 96a of the ring segment 46 that the projection 48 extends from.

The interfaces 92a, 92b between adjacent ring segments 46 are configured to prevent formation of a common metallic link in flux ring 24 fully about the axis MA. In the example show, the circumferential gap 94 extends between the radially inner and radially outer sides of flux ring 24. In the example shown, the circumferential gap 94 is non-linear between the inner and outer radial sides of the flux ring 24. The circumferential gap 94 can be considered to be circuitous. The circumferential gap 94 has a total length greater than the radial width between the radially inner and radially outer sides of the flux ring 24. The circumferential gap 94 extends radially and includes portions that extend circumferentially. The circumferential gap 94 extends fully axially through the flux ring 24. The circuitous circumferential gap 94 can improve the stiffness of flux ring 24.

In the example shown, the circumferential gap 94 has a varying width as the circumferential gap 94 extends between the outer and inner radial sides of the flux ring 24. In the example shown, circumferential gap 94 includes end gaps 110, base gap 112, and spacer gaps 114. End gaps 110 are disposed directly between the opposed circumferential ends 96a, 96b of the adjacent ring segments 46a, 46b. The end gaps 110 have width EW. Base gap 112 is disposed directly between the projection base 102 and cavity base 108. The base gap 112 has width BW. Spacer gaps 114 are disposed directly between an opposed catch 100a, 100b and retainer 106. Spacer gaps 114 have width SW. The gap widths EW, BW, and SW can be considered to form circumferential widths.

In the example shown, the circumferential gap 94 is formed such that circumferentially spaced portions of the circumferential gap 94 circumferentially overlap with each other. In the example shown, the circumferential gap 94 is formed such that portions of the circumferential gap 94 radially overlap with other portions of the circumferential gap 94 with material of a ring segment 46 directly between those radially overlapping portions of the circumferential gap 94. In the example shown, the projection 48 forms the material of the ring segment 46 that is directly radially between those radially overlapping portions of the circumferential gap 94. The circumferential gap 94 in the example shown includes three portions that circumferentially overlap each other with material of the flux ring 24 disposed directly between each of those overlapped portions. In the example shown, base gap 112 circumferentially overlaps with spacer gap 114 with a catch 100a, 100b disposed directly therebetween and spacer gap 114 circumferentially overlaps with end gap 110 with a retainer 106 disposed directly therebetween. Each of an end gap 110, a spacer gap 114, and the base gap 112 circumferentially overlap each other in the example shown.

Circumferential gap 94 is sized to inhibit formation of a common metallic link fully about the axis MA. The width EW of end gaps 110 and the width BW of base gap 112 are smaller than the widths SW of spacer gaps 114. In some examples, the width EW can be the same as the width BW. Ring segments 46a, 46b may shift relative to each other during the assembly and potting process. Shifting the ring segments 46a, 46b such that circumferential end 96a of ring segment 46a contacts circumferential end 96b of ring segment 46b at interface 92a (e.g., such that end gaps 110 and/or base gap 112 shown in FIG. 12A are eliminated), creates metallic contact (e.g., a metallic link) between ring segment 46a and ring segment 46b. However, such shifting will also vary the widths of the circumferential gap 94 formed between circumferential end 96b of ring segment 46a and circumferential end 96a of ring segment 46b at interface 92b shown in FIG. 12B. The widths of the end gaps 110 and base gap 112 between circumferential end 96b of ring segment 46a and circumferential end 96a of ring segment 46b at interface 92b will increase if the end gaps 110 or base gap 112 at interface 92a are eliminated due to relative shifting. With the width SW of the spacer gaps 114 being larger than the widths of the end gaps 110 or base gap 112, the end gaps 110 and/or base gap 112 between circumferential end 96a of ring segment 46a and circumferential end 96b of ring segment 46b will fully close such that the ring segments 46a, 46b contact each other before the spacer gap 114 at interface 92b closes. As such, the circumferential gap 94 at interface 92b will remain open between ring segments 46a, 46b and fully radially through flux ring 24 even if the ring segments 46a, 46b are in contact at another location about the axis MA. As such, the relative sizing prevents formation of a common metallic link fully about the motor axis MA.

Mounting slot 52 is also shown with a locator 80 extending into the mounting slot 52. As shown, the locator 80 can be partially disposed within the mounting slot 52 and can extend partially out of the mounting slot 52, though it is understood that not all examples are so limited. The mounting slot 52 is disposed circumferentially between a circumferentially outermost tooth 40 of the ring segment 46 and circumferential end 96a of the ring segment 46 that is circumferentially closest to that circumferentially outermost tooth 40. The mounting slot 52 is spaced circumferentially from the circumferential gap 94 such that the mounting slot 52 does not radially overlap with a circumferential gap 94. The mounting slot 52 is further positioned to not radially overlap with an axial return 28. Positioning the mounting slot 52 in a trench 54 and not radially overlapping with an axial return 28 places mounting slot 52 such that removal of material to form mounting slot 52 does not interfere with flux flow through the flux ring 24.

The projection 48 and receiver 50 interface provides significant advantages. The projection 48 extends into the receiver 50 such that adjacent ring segments 46 radially overlap with each other. The projection 48 extends into the receiver 50 such that projection 48 is radially overlapped by the material defining receiver 50 both radially inward from projection 48 and radially outward from projection 48. The adjacent ring segments 46 are radially overlapping each other provides improved stiffness to the flux ring 24, improving reliability and life of the motor 10. The increased stiffness can also allow for formation of a radially smaller air gap 30, providing for more efficient motor operation.

Circumferential gap 94 is sized to prevent formation of a common metallic link about the axis MA, preventing shorting and generation of eddy currents. Ring segments 46a, 46b are spaced from each other such that at least one circumferential gap 94 is maintained between the ring segments 46 even if the ring segments 46 contact each other at another location about the axis MA. The spacing widths SW are larger than the end widths EW or the base width BW to maintain circumferential gap 94 at at least one location about the axis MA.

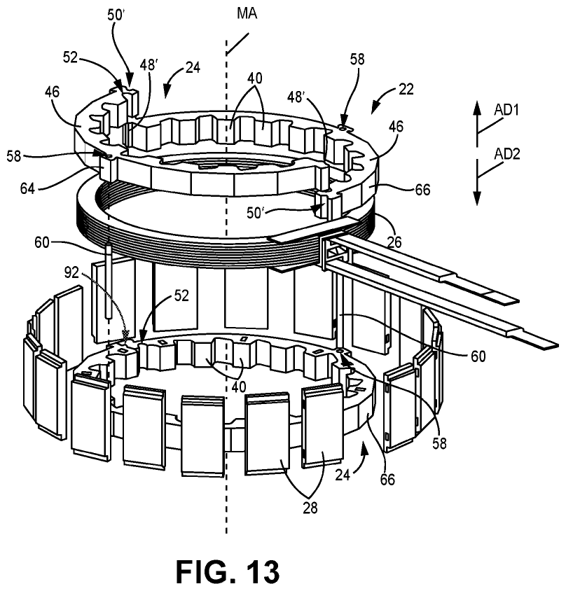

FIG. 13 is an exploded view of a stator phase 22. Flux rings 24; axial returns 28, and coil 26 of stator phase 22 are shown. Flux rings 24 are each formed by multiple ring segments 46. It is understood that other stator phases 22 of the motor 10 can be identical to the stator phase 22 shown.

Each flux ring 24 supports an annular array of teeth 40. A coil 26 is located axially between the two annular arrays of teeth 40 of the pair of annular arrays of teeth 40. An annular array of axial returns 28 radially overlap with the coil and span between the pair of flux rings 24. The flux rings 24 and the axial returns 28 can be formed from stacks of metallic laminations, such as steel laminations.

Each annular array of teeth 40 is formed from a plurality of ring segments 46. Each ring segment 46 can also be referred to as a tooth array segment. In the example shown, two ring segments 46 form each annular array of teeth 40, however a different number of ring segments 46 may form each annular array of teeth 40, or a single ring may form all teeth 40 of an annular tooth array.

Each ring segment 46 includes a projection 48′and a receiver 50′ on its circumferential ends. Each receiver 50′ receives a projection 48′ of an adjacent ring segment 46 to align the ring segments 46. Each ring segment 46 may be formed from a single stack of steel laminations, such that multiple teeth 40 are formed from the same stack of steel laminations. The ring segments 46 do not contact each other to form a common metallic link about the axis MA so as to not support electrical conduction between them. Potting material may fill in between the segments and otherwise embed the various stator components. For example, the potting compound can fill in between the radially overlapped projection 48′and receiver 50′of adjacent ring segments 46.

In the example shown, the projection 48′is configured to extend into the receiver 50′ such that the adjacent ring segments 46 radially overlap with each other. The receiver 50′ radially overlaps with the projection 48′ radially inward of the projection 48′ and radially outward of the projection 48′. Unlike the projection 48 and receiver 50 shown in FIGS. 11-12B, the projection 48′ is not bracketed by the receiver on both circumferential sides of the projection 48′. The receiver 50′does not extend to be directly circumferentially between the projection 48′ and the circumferential end of the ring segment 46 that the projection 48′ extends from. In the example shown, no portion of the retainer 50′ is disposed directly circumferentially between the projection 48′ and the circumferential end of the ring segment 46 that the projection 48′ extends from. When ring segments 46 are assembled together, a circuitous circumferential gap 94 is formed between the adjacent ring segments 46 such that the adjacent ring segments 46 are not in contact. The circumferential gap 94 can be filled in with potting compound.

Each ring segment 46 further includes one or more mounting slots 52. In the example shown, each ring segment 46 includes a single mounting slot 52. The mounting slot 52 is configured to receive a locator 80 of an annular bracket 42. The locator 80 can be formed as a post or other structure that projects axially to extend into the mounting slot 52. The mounting slot 52 is open on a radial side of the mounting slot 52 in the example shown. It is understood, however, that not all examples are so limited. For example, the mounting slot 52 could be open on only one or both axial ends and enclosed radially between those one or more end openings. As such, the mounting slot 52 can be formed as a bore in various examples. The mounting slot 52 is formed on a radial side of ring segment 46 oriented towards the rotor 12. The mounting slot 52 is disposed on an opposite radial side of the flux ring 24 from the axial returns 28. In the example shown, the mounting slot 52 is formed on an inner radial side of the ring segment 46.

Each ring segment 46 further includes an alignment slot 58 that is configured to receive a pin 60, the pin 60 spanning between the flux rings 24 which form the stator phase 22. Pins 60 can be formed from a non-ferrous material. For example, the pins 60 can be formed from a polymer, among other options. The pins 60 extending between flux rings 24 align the teeth 40 of the respective flux rings 24 of the same stator phase 22. The pins 60 align the flux rings 24 to align the teeth 40 of the opposed flux rings 24 to facilitate formation of a flux circuit in stator phase 22 for flux flow for interaction with magnetic fields of the rotor 12 for driving of the rotor 12. Each pin 60 spans between and extends into axially aligned alignment slots 58 on the opposed flux rings 24 of the stator phase 22. The pair of flux rings 24 of a stator phase 22 are fixed in orientation by at least one pin 60 that extends between and interfaces with each flux ring 24 of the pair of flux rings 24 of the stator phase 22.

In the example shown, the alignment slot 58 is open axially in both axial directions AD1, AD2 along the motor axis MA. Having the alignment slot 58 open in both axial directions AD1, AD2 allows for identically formed flux rings 24 to be used on either axial side of the coil 26. In the example shown, the alignment slot 58 is radially closed along a full axial length of the alignment slot 58. The pins 60 extending between ring segments 46 align the teeth 40 of the respective flux rings 24 of the same stator phase 22.

In the example shown, the alignment slots 58 are formed in ring tabs 64 that project from ring surface 66 of the flux ring 24. The ring surface 66 supports the axial returns 28. The axial returns 28 can interface with and contact the ring surface 66. In the example shown, the ring surface 66 is faceted and each facet supports a single axial return 28. The ring tabs 64 project radially relative to the ring surface 66. The ring tabs 64 project radially outward in the example shown in which motor 10 is an inner rotator, but it is understood that ring tabs 64 can project radially inward in examples in which motor 10 is an outer rotator.

Ring tabs 64 project radially such that alignment slots 58 are spaced radially from ring surface 66. Alignment slots 58 can circumferentially overlap with axial returns 28. As such, pins 60 can circumferentially overlap with axial returns 28.

Pins 60 extend between the flux rings 24 such that pins 60 radially overlap with both flux rings 24 of the stator phase 22 and such that pins 60 radially overlap with coil 26 of the stator phase 22. Pins 60 circumferentially overlap with axial returns 28. Pins 60 do not radially overlap with axial returns 28 in the example shown. Instead, pins 60 are disposed circumferentially between axial returns 28. Projecting ring tabs 64 radially from the main body portion of flux ring 24 positions pins 60 at locations to interface with and align flux rings 24 while not interfering with flux flow through flux rings 24. In the example shown, a pin 60 interfaces with each ring segment 46 of a flux ring 24 such that pins 60 can align axially overlapped ring segments 46 relative to each other. The stator phase 22 can include a same number of pins 60 as the number of ring segments 46 of each flux ring 24 of the stator phase 22, though it is understood that not all examples are so limited. For example, each ring segment 46 can include multiple alignment slots 58 such that each ring segment 46 interfaces with multiple pins 60.

Pins 60 provide significant advantages. In the example shown, pins 60 extend into alignment slots 58 formed on the opposed flux rings 24. Pins 60 locate the opposed flux rings 24 relative to each other for desired alignment between the arrays of teeth 40 of the two flux rings 24. Pins 60 are positioned to not interfere with flux flow and can align flux rings 24 without interfering with operation of motor 10. Pins 60 can fix flux rings 24 relative to each other to maintain alignment during assembly, such as during potting of the stator 14.

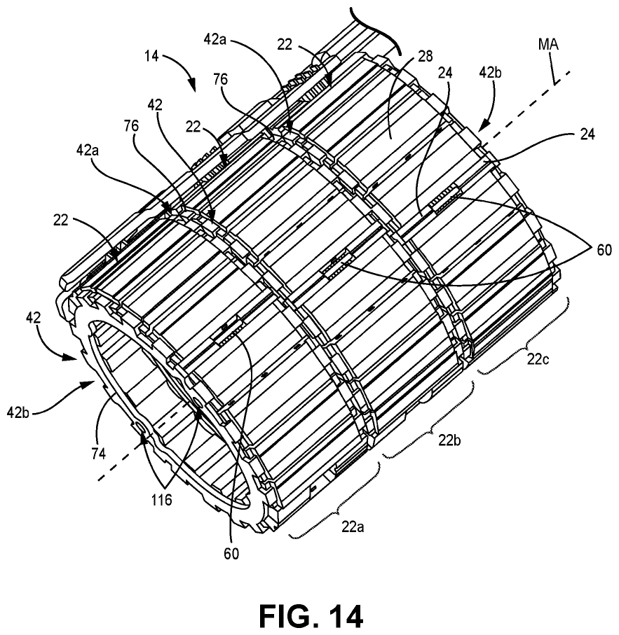

FIG. 14 is an isometric view of a stator 14. Stator phases 22a-22c of stator 14 are shown. As shown, pins 60 extend between and connect flux rings 24 within a single stator phase 22 of the stator 14. The pins 60 do not extend between adjacent stator phases 22 in the example shown. Such pins 60 can be considered to form intra-phase aligners that align flux rings 24 for a single stator phase 22. Annular brackets 42 are shown for aligning adjacent stator phases 22. The annular brackets 42 can be considered to form inter-phase aligners.

In the example shown, outer annular brackets 42b interface with the axially outer ends of the stator 14 while inner annular brackets 42a are disposed directly axially between adjacent stator phases 22 and interface with each of those axially adjacent stator phases 22. As shown, each axial return 28 is held by a pair of retaining tabs 76 interfacing with the axial returns 28 at opposite axial ends of the axial returns 28. As shown, each axial return 28 is held on a first flux ring 24 of the stator phase 22 of that axial return 28 by a retaining tab 76 of one annular bracket 42 and is held on a second flux ring 24 of the stator phase 22 of that axial return 28 by a retaining tab 76 of a second annular bracket 42. For each annular bracket 42, a single retaining tab 76 of that annular bracket 42 interfaces with a single axial return 28.

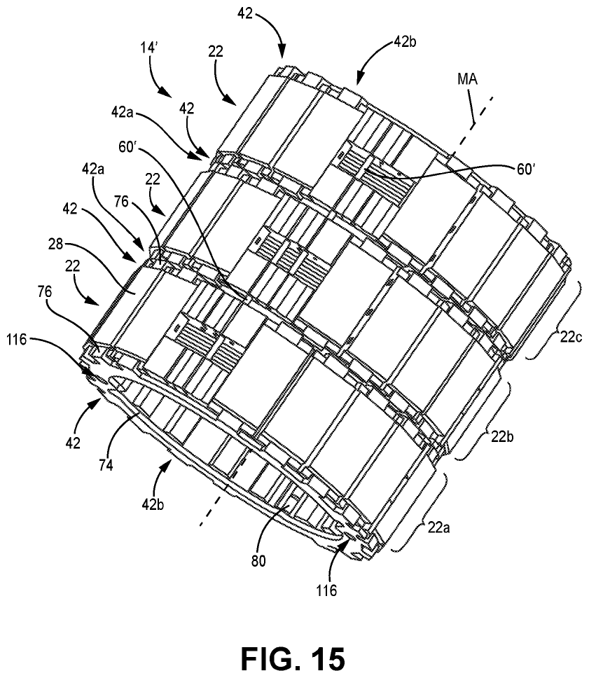

As shown, outer annular bracket 42b can include one or more bracket openings 116 that are disposed within bracket body 74. The bracket opening 116 can extend fully axially through the outer annular bracket 42b, among other options. The bracket opening 116 can receive an aligner to circumferentially align the outer annular bracket 42b, and thus align the stator phase 22 interfacing with outer annular bracket 42b, about the motor axis MA. For example, the aligner can be disposed within a mandrel and can extend into the bracket opening 116 to align the outer annular bracket 42b about the axis MA. Aligning the outer annular bracket 116 also aligns the other stator phases 22 of the stator 14 as those stator phases 22 are aligned relative to each other by the other annular brackets 42. Such a configuration facilitates alignment during assembly, such as during potting of the stator 14. FIG. 15 is an isometric view of a stator 14′. Stator phases 22a-22c of stator 14′ are shown. Stator 14′ is substantially similar to stator 14, except that stator 14 includes pins 60′that extend between and align adjacent stator phases 22. The pins 60′ connect flux rings 24 within a single stator phase 22 of the stator 14′and also project beyond the single stator phase 22 to interface with one or more flux rings 24 of an adjacent stator phase 22. A single pin 60′ can interface with both flux rings 24 of a first stator phase 22 and interface with one or more flux rings 24 of an adjacent second stator phase 22. The at least one pin 60 can thus extend beyond the first stator phase 22 and interface with one or multiple flux rings 24 of an other stator phase 22 of the plurality of stator phases 22 of the stator 14.

In the example shown, the single pin 60′ interfaces with both flux rings 24 of a first stator phase 22 (e.g., stator phase 22a) and interfaces with both flux rings 24 of an adjacent second stator phase 22 (e.g., stator phase 22b). Such pins 60′ can be considered to form intra-phase aligners that align flux rings 24 for a single stator phase 22. The pins 60′ can further be considered to form inter-phase aligners that align adjacent stator phases 22. As shown, a single pin 60′ can interface with both flux rings 24 of a first stator phase 22 and both flux rings 24 of a second stator phase 22. A second pin 60′ can interface with the both flux rings 24 of the second stator phase 22 and with both flux rings 24 of a third stator phase 22. The pins 60′ extending between adjacent stator phases 22 align the adjacent stator phases 22, such as for aligning the stator phases 22 for provision of the electrically offset signals to each stator phase 22 for driving rotation of rotor 12. As shown, stator 14′ can include annular brackets 42 as inter-phase aligners and can include pins 60′ as inter-phase aligners. In such an example, annular brackets 42 may not include locators 80 as pins 60′ align the adjacent stator phases 22 relative to each other. It is understood that some examples can include pins 60′ as inter-phase aligners without including annular brackets 42.

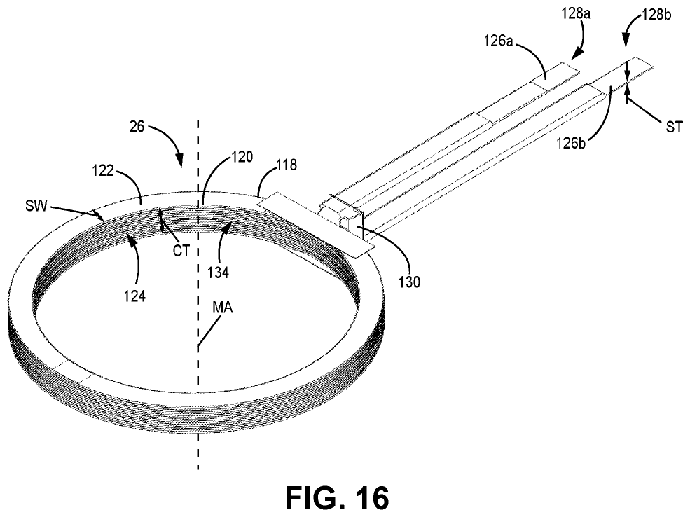

As shown, outer annular bracket 42b can include one or more bracket openings 116 that are disposed within bracket body 74. The bracket opening 116 can extend fully axially through the outer annular bracket 42b, among other options. The bracket opening 116 can receive an aligner to circumferentially align the outer annular bracket 42b, and thus align the stator phase 22 interfacing with outer annular bracket 42b, about the motor axis MA. For example, the aligner can be disposed within a mandrel and can extend into the bracket opening 116 to align the outer annular bracket 42b about the axis MA. Aligning the outer annular bracket 116 also aligns the other stator phases 22 of the stator 14′ as those stator phases 22 are aligned relative to each other by the other annular brackets 42. Such a configuration facilitates alignment during assembly, such as during potting of the stator 14′. FIG. 16 is an isometric view of a coil 26. The coil 26 is formed from ribbon strand 118 in the example shown. The ribbon strand 118 is formed from electrically conductive material, such as copper. The ribbon strand 118 is wound along the axis MA such that a narrow side 120 of the ribbon strand 118 is radially orientated and a broad side 122 of the ribbon strand 118 is axially oriented. The ribbon strand 118 is stacked such that layers of the ribbon strand 118 are stacked axially. The stacked ribbon strand 118 can be considered to form a stacked body 124 of the coil 26. The ribbon strand 118 is wound along the axis such that a narrow side 120 of the ribbon strand 118 is oriented radially and layers of the ribbon strand 118 are stacked axially.

The ribbon strand 118 has a strand width SW. The strand width SW is a width of the broad side 122 of the ribbon strand 118. The ribbon strand 118 further has a strand thickness ST, which is a thickness of the narrow side 120 and between the two broad sides 122 of the ribbon strand 118. In the example shown, the ribbon strand 118 is stacked along the axis MA such that the stacked body 124 has an axial thickness CT. The axial thickness CT of the stacked body 124 is larger than the stand width SW in the example shown.

The ends 126a, 126b of the ribbon strand 118 extend away from the stacked body 124 to form terminals 128a, 128b of the coil 26. The ends 126a, 126b are spaced radially from the stacked body 124 of coil 26. In some examples, a terminal support 130 holds the ends 126a, 126b as they extend away from the stacked body 124 of coil 26. The ends 126a, 126b can also be referred to as terminal ends. The terminal support 130 spaces and aligns the terminals on the axial ends of the coil 26. Each coil 26 can be coaxial with the axis MA, such that each coil 26 of each stator phase 22 is coaxial with the axis MA, which is the axis of rotation of the rotor 12.

Low voltage, high current operation of a coil 26 requires the support of thick wires. But thick wires risk induced currents and thus cause unwanted heating. A thinner wire supports less inducted current and thus less unwanted heating, but requires higher voltage to get equivalent performance and further is subject to resistive heating. But such convention assumes a round wire. A ribbon strand 118 (instead of a round wire) imposes a grain that is similar to how stacks of laminations that form part of the ring segments 46 and/or axial returns 28 impose directionality and resist the development of eddy currents, which reduces unwanted heating. As such, an axially stacked coil 26 as shown allows low voltage, high current with a minimum of losses and heat generation while resisting formation of eddy currents.

Stacking ribbon strand 118 axially also allows for greater packing efficiency of the material (e.g., copper) forming the coil 26. Stacking round wire creates gaps between that wire. The flat ribbon strand 118 can be stacked axially without the formation of such gaps that are created in round wire. Such a configuration provides for greater packing density of material forming the coil 26 in the same envelope, providing for greater efficiency in a smaller area.

In the example shown, each turn of the ribbon strand 118 forming the stacked body 124 forms the portion of coil 26 radially closest to rotor 12. The rotor side 134 of coil 26, which is the radial side of coil 26 oriented towards rotor 12 and radially closest to rotor 12, is formed by multiple turns of the stacked body 124. In the example shown, the rotor side 134 is formed by each turn of the stacked body 124. As such, each turn of the stacked body 124 is exposed at rotor side 134. The coil 26 does not include a single discrete layer that itself forms the closest portion to rotor 12. Instead, the rotor side 134 of coil 26 is formed by each turn of the ribbon strand 118 forming the stacked body 124. Each turn is a single loop about the axis MA such that the stacked body 124 can be considered to be formed by multiple turns or loops stacked together.

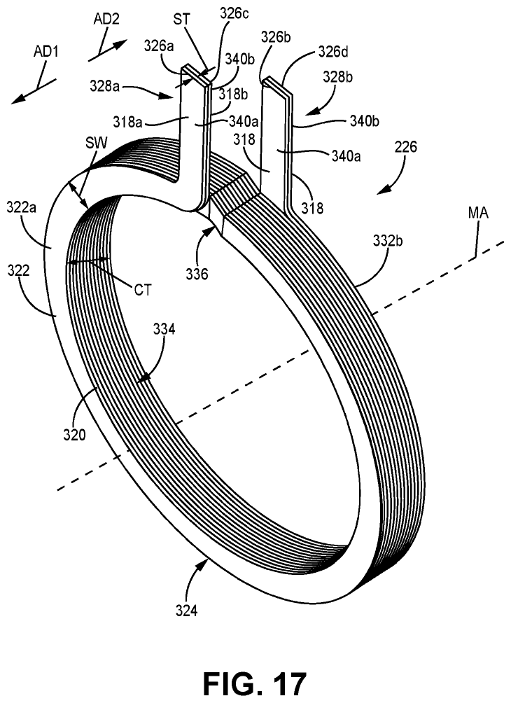

FIG. 17 is an isometric view of coil 226. The coil 226 shown in FIG. 17 can be substituted for any coil 226 shown or referenced herein. Coil 226 is substantively similar to coils 26 shown elsewhere in the disclosure, except as discussed below. Similar or same components of coil 226 as compared to coils 26 are numbered with the same reference number except increased by “200” (e.g., coil 226 and coil 26).

Coils 226 of the present disclosure can be formed from ribbon strand 318 that is orientated so that the broad side 322 (e.g., the larger flat dimension) of the ribbon strand 318 is axially orientated with respect to the axis MA and extends radially with respect to the axis MA, and the ribbon strand 318 is wound so that the narrow side 320 (e.g., the smaller thin dimension) is layered upon itself by being stacked along the axis. The narrow side 320 of each layer of ribbon strand 318 forming the stacked body 324 is oriented radially and extends axially. The broad side 322 of the ribbon strand 318 is oriented axially and extends radially relative to the axis MA. The ends 326a, 326b of the ribbon strand 318 project away from the stacked body 324 to form terminals 328a, 328b of the coil 226. The ends 326a, 326b can also be referred to as terminal ends. The ribbon strand 318 is wound along the axis such that a narrow side 320 of the ribbon strand 318 is oriented radially and layers of the ribbon strand 318 are stacked axially.

The ribbon strand 318 is stacked along the axis MA to form the stacked body 324 of coil 226. The ribbon strand 318 has a strand width SW. The strand width SW is a width of the broad side 322 of the ribbon strand 318. The ribbon strand 318 further has a strand thickness ST, which is a thickness of the narrow side 320 and between the two broad sides 322 of the ribbon strand 318. In the example shown, the ribbon strand 318 is stacked along the axis MA such that the stacked body 324 has an axial thickness CT. The axial thickness CT of the stacked body 324 is larger than the stand width SW in the example shown.

Stacked body 324 includes bend 336. Bend 336 shifts the layers of the ribbon strand 318 axially. The bend 336 offsets the layers of the ribbon strand 318 axially. The bend 336 axially offsets adjacent turns of the ribbon strand 318. The bend 336 is disposed circumferentially between the terminals 328a, 328b in the example shown. Forming the bend 336 can allow the coil 226 to be flat and more compact axially within the stator 14 without wasting space inside of stator 14. For example, without the bend 336 each of the first and second ends 326a, 326b of the ribbon strand 318 would protrude axially on the axial ends of the coil 226 while the lamination pieces of the motor 10 (e.g., flux rings 24) may not be able to make room for such protrusions without sacrificing otherwise functional material space.

In the example shown, the bend 336 allows the axially outer layers of coil 226 to be generally flat about the axis MA. In the example shown, the axially outer faces 332a, 332b of each side of the stacked body 324 is planar orthogonal to the axis MA on both circumferential sides of the bend 336. For example, starting at terminal 328a, the ribbon strand 318 extends radially to the stacked body 324. The ribbon strand 318 then extends circumferentially about the axis MA until reaching the bend 336 to form a first axial face 332a of the stacked body 324. The portions of the ribbon strand 318 on each circumferential side of the bend 336 that form axially outer face 332a of stacked body 324 circumferentially overlap each other and can be considered to be circumferentially aligned. At the bend 336, the ribbon strand 318 shifts in axial direction AD2 to not circumferentially overlap with the axially outermost layer and the ribbon strand 318 extends about the axis MA until again reaching the bend 336 to form a second layer or turn of the stacked body 324. Subsequent layers are stacked on top of each other until reaching the opposite axially outer layer of the stacked body 324. From the bend 336, the ribbon strand 318 forming the axial face 332b extends about the axis MA until reaching the bend 336 again to form that second axially outer layer. The ribbon strand 318 then extends radially to form terminal 328b. Each layer or turn of the ribbon strand 318 circumferentially overlaps with itself. In the example shown, each layer or turn of the ribbon strand 318 circumferentially overlaps with itself for a majority of the circumference about the axis MA. In some examples, layers or turns of the ribbon strand 318 extends more than 350-degrees about the axis MA.

Bend 336 offsets the stacked turns of ribbon strand 318 forming the stacked body 324. The ribbon strand 318 extends from end 326a and about the axis MA to form an axially outer layer of the stacked body 324. That axially outer layer extends about the axis MA and approaches the beginning of that outer layer. Bend 336 shifts the ribbon strand 318 axially such that a second layer is stacked adjacent to the outer layer. The layers continue to stack until the opposite outer layer is formed. That opposite outer layer is aligned with itself circumferentially and extends to end 326b. The bend 336 can be disposed at least partially circumferentially between the first terminal 328a and the second terminal 328b along a shortest circumferential distance between the first terminal 328a and the second terminal 328b.

In the example shown, each turn of the ribbon strand 318 forming the stacked body 324 forms the portion of coil 226 radially closest to rotor 12. The rotor side 334 of coil 226, which is the radial side of coil 226 oriented towards rotor 12 and radially closest to rotor 12, is formed by multiple turns of the stacked body 324. In the example shown, the rotor side 334 is formed by each turn of the stacked body 324. As such, each turn of the stacked body 324 is exposed at rotor side 334. The coil 226 does not include a single discrete layer that itself forms the closest portion to rotor 12. Instead, the rotor side 334 of coil 226 is formed by each turn of the ribbon strand 318 forming the stacked body 324. Each turn is a single loop about the axis MA such that the stacked body 324 can be considered to be formed by multiple turns or loops stacked together. It is understood that in outer rotator examples the rotor side 334 is oriented radially outward but is still formed by the stacked narrow sides 320 of the ribbon strand 318.

Bend 336 allows for stacking of ribbon strand 318 in a compact configuration. The bend 336 prevents the ends of a ribbon strand 318 from projecting axially outward relative to other portions of the stacked body 324. The compact configuration of coil 226 reduces the required space for accommodating coil 226 in stator 14, providing for a more compact motor configuration. The compact configuration of coil 226 also allows for closer assembly of flux rings 24 to coil 226, improving the efficiency of motor 10. Bend 336 allows for greater packing of the material forming coil 226 (e.g., copper) within the space occupied by coil 226 such that a greater percentage of that space is actually occupied by the material of coil 226 rather than by gaps. Stacking ribbon strand 318 radially requires a turnover between axially adjacent layers, each layer formed by multiple turns of the ribbon strand stacked radially, to provide the two terminals on the same radial side of coil 226. Such a turnover can reduce the packing efficiency because the turnover does not extend fully about the axis, which can lead to loss of a half turn or more. Axially stacking ribbon strand 318 with bend 336 improves the packing efficiency of the material forming coil 226 and provides for more efficient motor operation.

Multiple ribbon strands 318 can be wound together to form coil 226. In the example shown, coil 226 includes two ribbon strands 318a, 318b, though it is understood that other numbers of ribbon strand 318 (e.g., three, four, five, or more) can be wound together to form coil 226. In some examples, coil 226 can include a single ribbon strand 318 that is wrapped about the axis MA.

In the example shown, a first ribbon strand 318a and a second ribbon strand 318b are wound together. Each layer of the stacked body 324 is formed by the first and second ribbon strands 318a, 318b stacked together. In the example shown, the ribbon strands 318a, 318b are interleaved to form the stacked body 324, though it is understood that in various other examples the multiple ribbon strands 318 can form discrete ribbon stacks that are stacked axially rather than interleaved with each other. Each layer of the first ribbon strand 318a is axially adjacent to a layer of the second ribbon strand 318b with the ribbon strands 318a, 318b interleaved. In some examples, no layer of the first ribbon strand 318a is directly axially adjacent to another layer of the first ribbon strand 318a with the multiple ribbon strands 318a, 318b interleaved. In the example shown, only a single layer of the first ribbon strand 318a is directly axially adjacent to any layer of the second ribbon strand 318b. The ribbon strands 318a, 318b are both wound along the axis such that a narrow side 320 of each ribbon strand 318a, 318b is oriented radially and layers of each ribbon strand 318a, 318b are stacked axially.

In the example shown, the first ribbon strand 318a is directly axially next to the second ribbon strand 318b to form coil 226. Each turn of the first ribbon strand 318a is not directly axially adjacent to another turn formed by first ribbon strand 318a. Instead, each turn of the first ribbon strand 318a is directly axially adjacent to a turn formed by the second ribbon strand 318b. Similarly, second ribbon strand 318b is directly axially next to first ribbon strand 318a to form coil 226. Each turn of the second ribbon strand 318b is not directly axially adjacent to another turn formed by second ribbon strand 318b. Instead, each turn of second ribbon strand 318b is directly axially adjacent to a turn formed by first ribbon strand 318a. In the example shown, the first ribbon strand 318a forms the axial face 332a of stacked body 324 and the second ribbon strand 318b forms the axial face 332b of stacked body 324.

In the example shown, terminal 328a is formed by the end 326a of ribbon strand 318a and end 326c of ribbon strand 318b and terminal 328b is formed by the end 326b of ribbon strand 318a and the end 326d of ribbon strand 318b. The ends 326a-326d can also be referred to as terminal ends. Terminal face 340a of terminal 328a is formed by the first ribbon strand 318a and terminal face 340b of terminal 328a is formed by second ribbon strand 318b. Similarly, terminal face 340a of terminal 328b is formed by the first ribbon strand 318a and terminal face 340b of terminal 328b is formed by second ribbon strand 318b. The terminal faces 340a, 340b of each terminal 328a, 328b are oriented axially outward relative to the stacked body 324. The ends 326a, 326c of ribbon strands 318a, 318b, respectively, are adjacent to each other and can be in contact with each other to form the terminal 328a. The ends 326b, 326d of ribbon strands 318a, 318b, respectively are adjacent to each other and can be in contact with each other to form the terminal 328b. The first and second ribbon strands 318a, 318b are disposed electrically in parallel.

Winding multiple ribbon strands 318 to form coil 226 as shown can reduce resistance by having the equivalent number of turns of conductive material as compared to a single wound ribbon but shorter and/or more numerous conductive paths. The two ribbon strands in the example shown in FIG. 17 are wound interleaved with respect to each other. The skin effect, in which an alternating current tends to avoid travel through the center of a solid conductor and instead prefers travel at the edges of the solid conductor, and rotor induced eddy currents are related to the axial thickness of each turn of the coil 226. Depending on frequency and other variables like rotor/stator geometry and current levels, there is an axial thickness where these losses are reduced to an acceptable level. If the voltage and geometry do not dictate a favorable thickness, the desired thickness value can be reached by running multiple ribbon strands 318 electrically in parallel as is described herein.

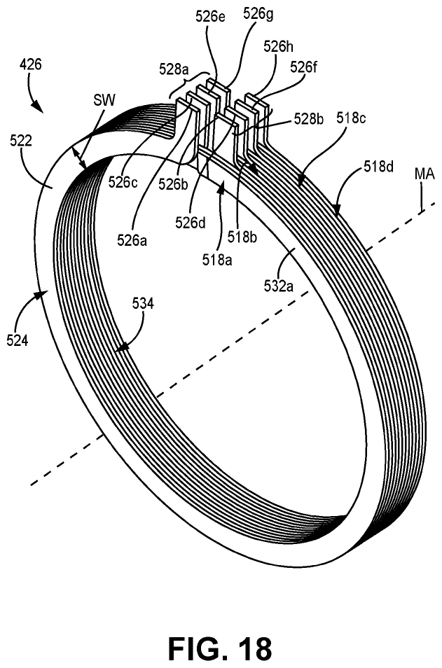

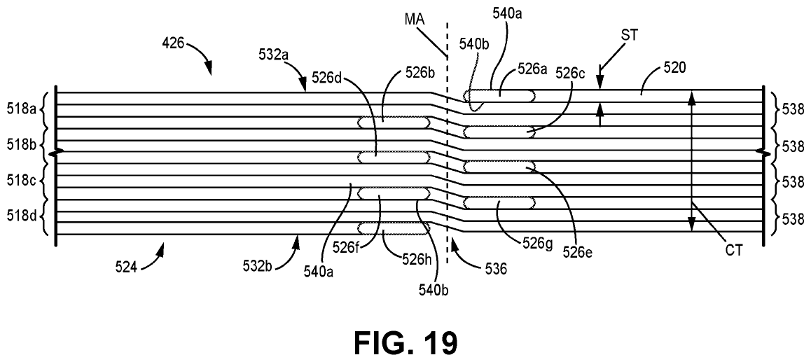

FIG. 18 is an isometric view of a coil 426. FIG. 19 is an enlarged plan view of a portion of coil 426. FIGS. 18 and 19 are discussed together. Coil 426 is substantively similar to coils 26 and coils 226 shown elsewhere in the disclosure, except as discussed below. Similar or same components of coil 426 as compared to coils 26 are numbered with the same reference number except increased by “400” (e.g., coil 426 and coil 26). Similar or same components of coil 426 as compared to coils 226 are numbered with the same reference number except increased by “200” (e.g., coil 426 and coil 226).

Coil 426 is formed by multiple ribbon strands 518 that are wound about the axis MA to form coil 426. In the example shown, four ribbon strands 518 (ribbon strands 518a-518d) are wound to form coil 426, though it is understood that more or fewer ribbon strands 518 can be included (e.g., two, three, five, six, ten, etc.). Each ribbon strand 518a-518d is wound along the axis MA such that a narrow side 520 of the ribbon strand 518a-518d is radially orientated and a broad side 522 of the ribbon strand 518a-518d is axially oriented. Each ribbon strand 518a-518d is stacked on itself such that layers of the each ribbon strand 518a-518d are stacked axially. Each ribbon strand 518a-518d is wound along the axis such that a narrow side 520 of the ribbon strand 518a-518d is oriented radially and layers of the ribbon strand 518a-518d are stacked axially.

Each ribbon strand 518 includes first and second ends that form the terminals for that ribbon strand 518. In the example shown, ribbon strand 518a includes ends 526a, 526b; ribbon strand 518b includes ends 526c, 526d; ribbon strand 518c includes ends 526e, 526f; ribbon strand 518d includes ends 526g, 526h. The ends 526a, 526c, 526e, 526g form first terminals 528a for each ribbon strand 518a-518d. The ends 526b, 526d, 526f, 526h form the second terminals 528b for each ribbon strand 518a-518d. The ends 526a-526h can also be referred to as terminal ends. The multiple ribbon strands 518a-518d are disposed electrically in parallel.

The ends 526a, 526c, 526e, 526g are arrayed axially and spaced axially from each other to form the first terminals 528a of the coil 426. The ends 526b, 526d, 526f, 526h are arrayed axially and spaced axially from each other to form the second terminals 528b of the coil 426. The first terminals 528a are disposed on one circumferential side of the bend 536 while the second terminals 528b are disposed on an opposite circumferential side of the bend 536 from the first terminals 528a. In the example shown, and unlike the example shown in FIG. 17, the four ribbon strands 518a-518d are wound as discrete ribbon stacks 538 that are stacked axially upon each other rather than interleaved together. In other examples, the multiple ribbon strands 518 can be interleaved together, similar to the example shown in FIG. 17.

As best seen in FIG. 19, the multiple ribbon strands 518 are stacked axially to form the stacked body 524 of coil 426. Each ribbon strand 518a-518d includes a bend 536 formed in the space between the two terminals 528a, 528b of that ribbon strand 518a-518d. Ribbon strand 518a is disposed at a first axial side of coil 426 and forms axial face 532a. Ribbon strand 518d is disposed at a second axial side of coil 426 and forms axial face 532b. Ribbon strands 518b, 518c are disposed directly axially between ribbon strand 518a and ribbon strand 518d. Ribbon strands 518b, 518c can be considered to form intermediate portions of coil 426 while ribbon strands 518a, 518d can be considered to form end portions of coil 426. Ribbon strand 518a forms axial face 532a of coil 426 and ribbon strand 518d forms axial face 532b of coil 426. The intermediate portions of coil 426 are not exposed at either axial end face 532a, 532b of the coil 426 in the example shown.

As shown, due to the bends 536 an axial layer of one of the ribbon strands 518a-518d may at least partially overlap (e.g., circumferentially) with an axial layer of another one of the ribbon strands 518a-518d. Furthermore, an axial layer of one of the ribbon strands 518a-518d may at least partially overlap (e.g., circumferentially) a terminal 528a, 528b of another ribbon strand 518a-518d of the coil 426. The ribbon strands 518a-518d are stacked axially relative to the motor axis MA. The bend 536 can be disposed at least partially circumferentially between the first terminals 528a and the second terminals 528b along a shortest circumferential distance between the first terminals 528a and the second terminals 528b. Each ribbon stack 538 is formed by a discrete ribbon strand 518a-518d. Each ribbon stack 538 includes a bend 536. The bends 536 of each ribbon stack 538 can be axially aligned to axially overlap. Gaps can be disposed between the axially aligned bends 536.

Axially stacking multiple discrete ribbon stacks 538 each formed from a ribbon strand 518 provides significant advantages. The first terminals 528a of each ribbon strand 518 are spaced axially relative to the first terminals 528a of the other ribbon strands 518. The first terminals 528a of each ribbon strand 518a-518d can axially overlap with each other. The second terminals 528b of each ribbon strand 518 are spaced axially relative to the second terminals 528b of the other ribbon strands 518. The second terminals 528b of each ribbon strand 518a-518d can axially overlap with each other. Each first terminal 528a and second terminal 528b has a first terminal face 540a and a second terminal face 540b that is exposed. The exposed terminal faces 540a, 540b of each terminal 528a, 528b increase the surface area of each ribbon strand 518 that is exposed which can assist in forming contact for electrical connection to each ribbon strand 518a-518d of the coil 426. The terminal faces 540a, 540b of each terminal 328a, 328b are oriented axially outward relative to the stacked body 524.

Stacking a large number of ribbon strands 518 interleaved with each other can create a relatively large bend 536 to accommodate the axial width of the stack of ribbon strands 518 interleaved together, which may result in an undesirably large coil 426 in the axial direction. Stacking the individual ribbon strands 518 axially provides for a more compact configuration of coil 426, saving space within stator 14. Further, each ribbon strand 518 having individually exposed first and second terminals 528a, 528b provides increased surface area as compared to a terminal formed by interleaved ribbon strands 518, facilitating electrical connection to each of the multiple ribbon strands 518 for provision of the electrical driving signals.

Each ribbon strand 518 has a strand width SW. The strand width SW is a width of the broad side 522 of the ribbon strand 518. The ribbon strand 518 further has a strand thickness ST, which is a thickness of the narrow side 520 and between the two broad sides 522 of the ribbon strand 518. In the example shown, the ribbon strand 518 is stacked along the axis MA such that the stacked body 524 has an axial thickness CT. The axial thickness CT of the stacked body 524 is larger than the stand width SW in the example shown.

In the example shown, each turn of each ribbon strand 518 forming the stacked body 524 forms the portion of coil 426 radially closest to rotor 12. The rotor side 534 of coil 426, which is the radial side of coil 426 oriented towards rotor 12 and radially closest to rotor 12, is formed by multiple turns of the stacked body 524. In the example shown, the rotor side 534 is formed by each turn of the stacked body 524. As such, each turn of the stacked body 524 is exposed at rotor side 534. The coil 426 does not include a single discrete layer that itself forms the closest portion to rotor 12. Instead, the rotor side 534 of coil 26 is formed by each turn of the ribbon strand 518 forming the stacked body 524. Each turn is a single loop about the axis MA such that the stacked body 524 can be considered to be formed by multiple turns or loops stacked together.

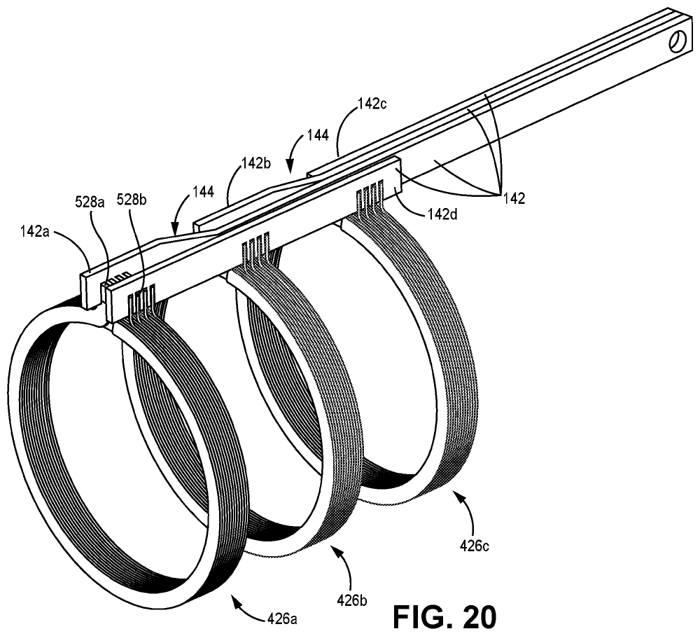

FIG. 20 is an isometric view showing multiple coils 426a-426c connected to electrical connectors 142. In the example shown, each coil 426a-426c is formed similar to coil 426 (FIGS. 18 and 19) that is formed by ribbon strand stacked in discrete ribbon stacks. The connectors 142 can be bus bars or other type of connector 142 that electrically connects to the terminals 528 of the respective coils 426. The connectors 142 can connect to a driver or other type of control circuitry (e.g., controller 16 (FIGS. 1 and 2)). Each coil 426a-426c can drive a respective stator phase 22 of the motor 10; for example, each coil 426a-426c can receive an electrical driving signal that is 120-degrees electrically offset with respect to the other electrical driving signals provided to the other coils 426a-426c.

As shown, the coils 426a-426c are connected to a common connector 142d for one set of the terminals 528b of the coils 426a-426c, and each coil 426a-426c is further connected to a respective discrete connector 142 for the other terminal 528a of the coils 426a-426c. In the example shown, the first coil 426a connects with the first connector 142a, the second coil 426b connects with the second connector 142b, and the third coil 426c connects the third connector 142c. Each of the coils 426a-426c is connected to the common connector 142d.

Multiple terminal connections are made with each of the first connector 142a, second connector 142b, and third connector 142c, because, as demonstrated previously, each coil 426a-426c can be comprised of multiple ribbon strands 518. The connectors 142a-142b have connector bends 144 to route around one another, as shown. In particular, the first connector 142a and the second connector 142b have connector bends 144 while the third connector 142c is straight, however other options are possible. The connector bends 144 facilitate connection to the individual coils 426a-426c even when the terminals of each coil 426a-426c that connect to the connectors 142a-142c, respectively, are axially aligned to axially overlap. The connector bends 144 facilitate routing of the connectors 142 axially while connecting to axially overlapped terminals.

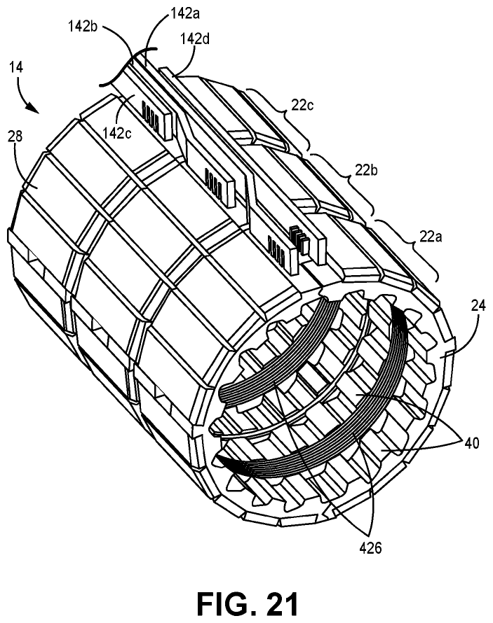

FIG. 21 is an isometric view of a stator 14. The stator 14 includes a first stator phase 22a, second stator phase 22b, and a third stator phase 22c. Each stator phase 22a-22c can be substantially identical. Each stator phase 22a-22c comprises a coil 426 located axially between annular flux rings 24 that each include an annular array of teeth 40. The coil 426 of a stator phase 22 polarizes pairs of the annular arrays of teeth 40 of the stator phase 22 to electromagnetically interact with magnets (and possibly concentrators in examples including concentrators) of the rotor 12. As compared to the array of three coils 426a-426c shown in FIG. 20, in FIG. 21 the full stator phases 22 are built around the coils 426 such that the first stator phase 22a, second stator phase 22b, and third stator phase 22c are axially arrayed. As shown, the terminals of each coil 426 can project radially at a location directly circumferentially between axial returns 28 of the stator phase 22 of that coil 426.

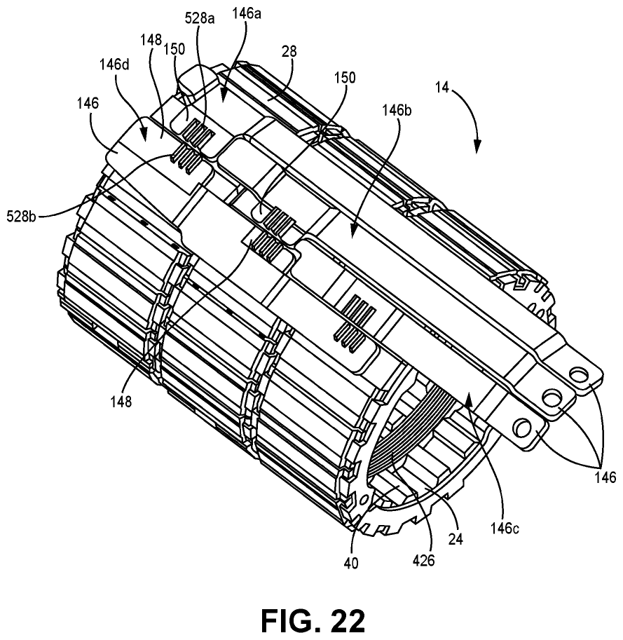

FIG. 22 is an isometric view of a stator 14 showing a connector 146 for electrically connecting a driver (e.g., controller 16 (FIGS. 1 and 2)) for providing electrical driving signals to the coils 426. In the example shown, the coils 426 are physically offset about the axis MA such that first terminals 528a of each coil 426 are circumferentially offset from first terminals 528a of other coils 426. In the example shown, the connectors 146a-146d are flat with a broad side oriented radially, unlike the connectors 142a-142d shown in FIGS. 20 and 21. Connectors 146a-146d reduce the radial size of stator 14, providing for a more compact configuration and providing space savings.

Common connector 146d connects to terminals 528b of each coil 426 of stator 14. Common connector 146d includes connector flanges 148 that extend circumferentially to interface with terminals 528b a first and second ones of the coils 426. The connector flanges 148 extend circumferentially to interface the terminals 528b of the first and second coils 426 that are circumferentially offset from the terminals 528b of the third coil 426.

As shown, each coil 426 connects to a discrete, individual connector 146a-146c in addition to the common connector 146d. In the example shown, the first coil 426 connects with the first connector 146a, the second coil 426 connects with the second connector 146b, and the third coil 426 connects the third connector 146c. Each of the coils 426 is connected to the common connector 146d. Multiple terminal connections are made with each of the first connector 146a, second connector 146b, and third connector 146c, because, as demonstrated previously, each coil 426 can be comprised of multiple ribbon strands 518 with each ribbon strand 518 each having discrete terminals 528a, 528b that are directly adjacent to each other and stacked together. The connectors 146a-146c themselves have connectors tabs 150 to route around one another and extend to the circumferentially offset first terminals 528a of the coils 426. In particular, the first connector 146a and the second connector 146b have connectors tabs 150 while the third connector 146c is straight, however other options are possible. The connectors tabs 150 facilitate connection to the individual coils 426 even when the terminals 528a of each coil 426 that connect to the connectors 146a-146c are circumferentially offset. In the example shown, the slots that receive the first terminals 528a are open circumferentially such that connection can be made by shifting the connector 146a-146c circumferentially to connect to the first terminals 528a.

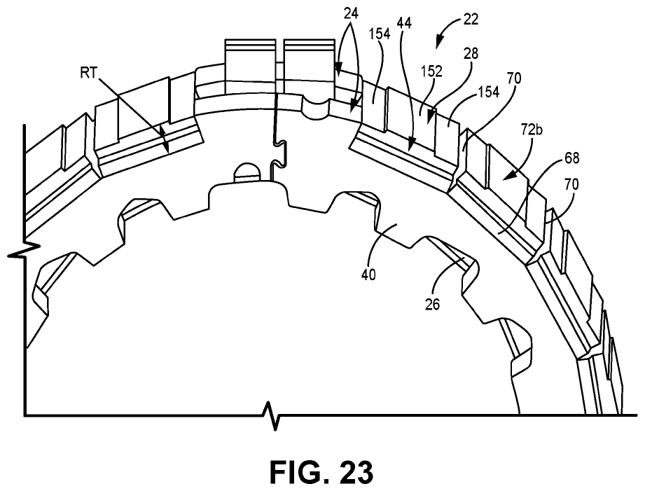

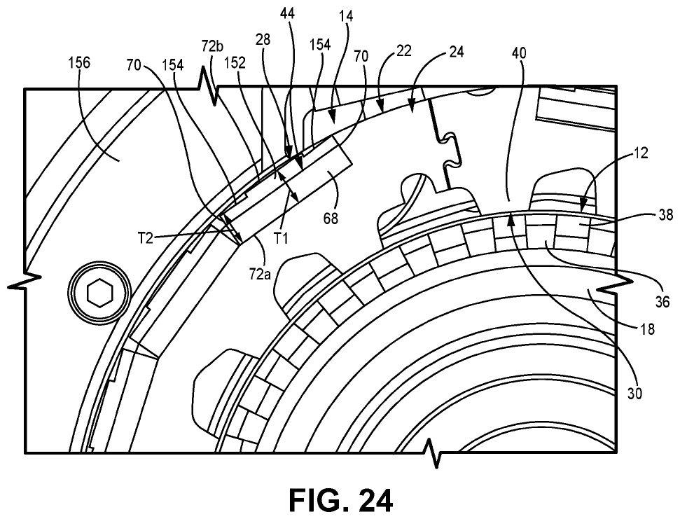

FIG. 23 is a partial isometric view of a stator phase 22. FIG. 24 is an axial end view showing a motor 10 with stator 14 and rotor 12 exposed. FIGS. 23 and 24 are discussed together. Stator phase 22 includes a pair of flux rings 24 and a coil 26 disposed directly axially between the opposed flux rings 24. Each flux ring 24 includes an annular array of teeth 40. Each stator phase 22 further includes an annular array of axial returns 28. The axial returns 28 are disposed on an opposite radial side of the flux rings 24 from the teeth 40. The teeth 40 are configured to be oriented radially towards the rotor 12 with stator phase 22 assembled within a motor 10.

An end notch 44, a return end 68, the return faces 72a, 72b, and the return sides 70 of axial returns 28 are shown. The return face 72b is oriented away from the rotor 12. It is understood that the return face 72b can be oriented radially outward from the motor axis MA in inner rotator examples while the return face 72b can be oriented radially inward towards motor axis MA in outer rotator examples.

Axial return 28 has a variable thickness RT. In the example shown, axial return 28 has a thickness T1 at a circumferential midpoint between return sides 70 and has a thickness T2 at the return sides 70. Return thickness T1 can be referred to as a radial body thickness and return thickness T2 can be referred to as a radial edge thickness. The return thicknesses T1, T2 are taken at locations axially between the end notches 44. The return thicknesses T1, T2 are taken between return face 72a and return face 72b. The return thickness T1 is larger than the return thickness T2. The return thickness of the axial return 28 decreases between the circumferential midpoint of axial return 28 and a return side 70. In the example shown, the return thickness of the axial return 28 decreases towards the return sides 70. The return thickness of the axial return 28 decreases between the circumferential midpoint and each return side 70 of the axial return 28. The axial return 28 has a first radial thickness T1 at a circumferential midpoint of the axial return 28, the axial return 28 has a second radial thickness T2 at a circumferential side 70 of the axial return 28, and the first radial thickness T1 is greater than the second radial thickness T2. Each axial return 28 of the annular array of axial returns 28 can have can be configured the same such that each axial return 28 has a similarly contoured return face 72b.

In the example shown, return face 72b is contoured to vary the return thickness RT of the axial return 28. The contouring of return face 72b is formed by steps in the example shown. While return face 72b is shown as stepped, it is understood that not all examples are so limited. For example, return face 72b can be smoothly contoured (e.g., curved) between the circumferential midpoint and each return side 70.

Return face 72b includes mid portion 152 and edge portions 154, in the example shown. The mid portion 152 has the thickness T1 and the edge portions 154 have the thickness T2. The edge portions 154 are stepped down from the mid portion 152 to form the variable thickness of the axial return 28.

In the example shown, return face 72b includes a set of three steps, formed by the mid portion 152 and the two edge portions 154, but it is understood that not all examples are so limited. For example, return face 72b can include more than three steps, such as five, seven, nine, or more. In the example shown, return face 72b includes a thickness change circumferentially between the circumferential midpoint and a circumferentially oriented return side 70. It is understood, however, that return face 72b can, in some examples, include more than one thickness change between the circumferential midpoint and a return side 70, such as two, three, four, five, ten, or more thickness changes.

The steps of the axial return 28 are formed such that various of the laminas forming axial return 28 have different thicknesses between the return face 72a and the return face 72b. Some of the laminas of an axial return 28 can have the same thickness as a circumferentially adjacent lamina or as both circumferentially adjacent laminas. Some of the laminas of an axial return 28 can have the same radial thickness as one adjacent lamina and can have a different radial thickness from another adjacent lamina. In some examples, a step can be formed between each of the laminas forming the axial return 28. As such, each lamina of the axial return 28 can have a different thickness from the circumferentially adjacent lamina.

As best seen in FIG. 24, the axial returns 28 are disposed radially between the flux rings 24 and a housing 156 of the motor 10. The stator 14 and rotor 12 are each at least partially disposed within the housing 156. The housing 156 can include a cylindrical inner surface that opposes the return faces 72b of the axial returns 28. The axial returns 28 are formed as discrete blocks or pieces, which are each formed from stacked laminas (laminas stacked circumferentially and extending axially). The axial returns 28 formed as discrete blocks forms a faceted surface of the stator phase 22 that opposes the housing 156. The contoured return faces 72b allow the axial returns 28 to be positioned physically closer to the housing 156, reducing the size of any radial gap between the axial returns 28 and the housing 156. Having a reduced thickness T2 at the return side 70 as compared to thickness T1 at the circumferential midpoint brings the axial returns 28 physically closer to the housing 156.

During operation, a thermal pathway is formed through the axial returns 28 and to the housing 156 to wick heat from the stator 14. However, potting compound fills in the space radially between the axial returns 28 and the housing 156. The epoxy potting compound has significantly less thermal conductivity than the metallic axial returns 28 and the metallic housing 156. The contoured return faces 72b allowing axial returns 28 to be placed physically closer to housing 156 facilitates thermal transfer by reducing the radial gap between axial returns 28 and housing 156.

While an electric motor has been used herein as an example, the machines and aspects of the same can be used as, or implemented in, electrical generators. As such, the present disclosure is not limited to motors, and can include electrical generators. An embodiment can be both a motor and a generator. The term electrical machine is used herein to refer to various embodiments which can be either or both.

While the invention(s) has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention(s) without departing from the essential scope thereof. Therefore, it is intended that the invention(s) not be limited to the particular embodiment(s) disclosed, but that the invention(s) may include all embodiments falling within the scope of the appended claims. Any single feature, or any combination of features from one embodiment show herein, may be utilized in a different embodiment independent from the other features shown in the embodiment herein. Accordingly, the scope of the invention(s) and any claims thereto are not limited to the particular to the embodiments and/or combinations of the features shown herein, but rather can include any combination of one, two, or more features shown herein.

1. An electric machine comprising:
a rotor configured to rotate on an axis; and
a stator spaced radially relative to the rotor and disposed about the axis, the stator comprising a plurality of stator phases disposed along the axis, each stator phase including:
a pair of flux rings, each flux ring including an annular array of teeth;
a coil disposed axially between the pair of flux rings and extending fully around the axis; and
an annular array of axial returns extending between the pair of flux rings to magnetically connect the pair of flux rings;
wherein a first coil of a first stator phase of the plurality of stator phases is wound from a first ribbon strand, the first ribbon strand wound along the axis such that a narrow side of the first ribbon strand is oriented radially and layers of the first ribbon strand are stacked axially.

2. The electric machine of claim 1, wherein the coil further comprises a second ribbon strand, the second ribbon strand would along the axis such that a narrow side of the second ribbon strand is oriented radially and layers of the second ribbon strand are stacked axially.

3. The electric machine of claim 2, wherein the first ribbon strand and the second ribbon strand are interleaved.

4. The electric machine of claim 2, wherein the first ribbon strand forms a first ribbon stack and the second ribbon strand forms a second ribbon stack that is stacked axially with the first ribbon stack.

5. The electric machine of claim 2, wherein a first axial face of a stacked body of the coil is formed by the first ribbon strand and a second axial face of the stacked body is formed by the second ribbon strand.

6. The electric machine of claim 2, wherein:
the first ribbon strand includes a first terminal and a second terminal;
the second ribbon strand includes a first terminal and a second terminal; and
the first terminal of the first ribbon strand is spaced axially from the first terminal of the second ribbon strand.

7. The electric machine of claim 6, wherein the first terminal of the first ribbon strand axially overlaps with the first terminal of the second ribbon strand.

8. The electric machine of claim 7, wherein the second terminal of the first ribbon strand axially overlaps with the second terminal of the second ribbon strand.

9. (canceled)

10. (canceled)

11. The electric machine of claim 2, wherein the first ribbon strand and the second ribbon strand are electrically in parallel.

12. The electric machine of claim 1, wherein the first ribbon strand includes a bend that axially offsets adjacent turns of the first ribbon strand.

13. The electric machine of claim 1, wherein an axial thickness of the coil is greater than a strand width of the first ribbon strand.

14. The electric machine of claim 1, wherein a first flux ring of the first stator phase includes a plurality of ring segments that each extend partially about the axis, wherein a first ring segment of the plurality of ring segments includes a first projection and a second ring segment of the plurality of ring segments includes a first receiver, the first projection extending into the first receiver such that the first ring segment radially overlaps with the second ring segment, and wherein the first projection includes a catch, the receiver includes a retainer, and the catch circumferentially overlaps with the retainer such that the retainer is directly circumferentially between the catch and a circumferential end of the first ring segment from which the first projection extends.

15.-18. (canceled)

19. The electric machine of claim 14, wherein the first projection includes a projection base spaced from a cavity base of the receiver by a base gap, the catch is spaced from the retainer by a spacer gap, and the circumferential end of the first ring segment from which the first projection extends is spaced from a circumferential end of the second ring segment into which the receiver extends by an end gap.

20. The electric machine of claim 19, wherein the spacer gap is disposed directly circumferentially between the base gap and the end gap.

21-28. (canceled)

29. The electric machine of claim 1, further comprising:
a plurality of annular brackets, each annular bracket interfacing with at least one of the annular arrays of axial returns to hold the at least one of the annular arrays of axial returns such that each annular array of axial returns is held by and between two annular brackets of the plurality of annular brackets.

30. The electric machine of claim 1, further comprising:
a first annular bracket interfacing with a first annular array of axial returns of the first stator phase to hold the first annular array of axial returns on a first flux ring of the pair of flux rings of the first stator phase.

31. The electric machine of claim 30, wherein the first annular bracket includes at least one locator that extends into a mounting slot of the first flux ring.

32. The electric machine of claim 30, wherein the first annular bracket includes a first plurality of retaining tabs interfacing with the first annular array of axial returns to hold the first annular array of axial returns on the first flux ring.

33.-88. (canceled)

89. An electric machine comprising:
a rotor configured to rotate on an axis; and
a stator spaced radially relative to the rotor and disposed about the axis, the stator comprising a plurality of stator phases disposed along the axis, a first stator phase of the plurality of stator phases including:
a first flux ring, the first flux ring having a plurality of first teeth;
a second flux ring, the second flux ring having a plurality of second teeth;
a first coil extending fully annularly about the axis and disposed directly axially between the first flux ring and the second flux ring; and
a first annular array of axial returns extending about the axis and disposed on an opposite radial side of the first flux ring from the rotor; and
a first annular bracket interfacing with the first annular array of axial returns to hold the first annular array of axial returns on the first flux ring.

90. The electric machine of claim 89, further comprising:
a second annular bracket interfacing with the first annular array of axial returns to hold the first annular array of axial returns on the second flux ring, the second annular bracket disposed on an opposite axial side of the first stator phase from the first annular bracket.

91.-180. (canceled)
